(19) United States
(12) Patent Application Publication
(10) Pub. No.: US 2005/0221856 A1
(43) Pub. Date: Oct. 6, 2005

(54) Cellular terminal image processing system, cellular terminal, and server

(76) Inventors: Takashi Hirano, Tokyo (JP); Yasuhiro Okada, Tokyo (JP)

Correspondence Address: BIRCH STEWART KOLASCH & BIRCH, PO BOX 747, FALLS CHURCH, VA, 22040-0747, US

(21) Appl. No.: 10/498,267

(22) PCT Filed: Nov. 26, 2002
(86) PCT No.: PCT/JP02/12281

§ 371 Date: Jun. 8, 2004

(30) Foreign Application Priority Data
Dec. 10, 2001 (JP) 2001-376254

(51) Int. Cl. H04M 1/00

(52) U.S. Cl. 455/557; 455/575.1

(57) ABSTRACT

A mobile-terminal-type image processing system provides highly convenient translation function using images photographed by a camera of the mobile terminal.

The mobile-terminal-type image processing system includes: a mobile terminal 101 for sending data that includes images photographed by the camera of the mobile terminal 101, keywords inputted through a input key unit 103, types of processing service, or information related to the mobile terminal; and server 109 for translating a plurality of extracted character strings corresponding to one character string included in the received images by a recognizing unit 114 and a in-image character string translating unit 115, or translating generated relevant text corresponding to received keywords and sending to the mobile terminal 101 results of translating.

### TECHNICAL FIELD

The present invention relates to mobile-terminal-type image processing systems, mobile terminals, and servers for translating characters included in images photographed by cameras of the mobile terminals.

### BACKGROUND ART

In recent years, commercialization of mobile terminals in which a camera is mounted has become increasingly popular. A system that recognizes character strings included in images photographed by the camera of the mobile terminal and translates text of the recognized result is disclosed in Japanese Laid-Open Patent Publication 1997-138802. The system has a character-recognizing process and a translating process in the mobile terminal, and by using those processes, recognizes and translates the character strings included in the images photographed by the camera. However, in this system, there is a problem in that sophisticated character recognizing and translating processes are difficult due to the limitation of the mobile terminal size.

In contrast, a system that firstly sends images photographed by a camera of a mobile terminal (mobile telephone) to an outside server and returns the result of recognition and translation of characters in the images, which is processed on the server side, to the mobile terminal, is suggested in Japanese Laid-Open Patent Publication 1998-134004. In this system, sophisticated processes may be available because character recognition and translation are carried out on the high-processing-performance server side. Hereinafter, the operations of the system will be described using FIG. 25.

FIG. 25 is a flowchart that illustrates a processing procedure relating to a conventional mobile-terminal-type image processing system. The processing procedures are divided into two processes: a process in the mobile terminal and a process in the server.

Firstly, on the mobile terminal side, a user photographs images with a camera that is installed in or connected to the mobile terminal. In this case, a handwritten memo on paper or a part of a printed document is read (Step ST1). A required service relating to the read images is then specified. As the service, a translation of character strings included in the images photographed in Step ST1 or a data base search with a key word made of a character is specified, for example. In this case, the service of translating character strings would be specified (Step ST2). After these steps, the photographed images and the specified service requirements are sent to the server (Step ST3).

Next, on the server side, when the images and the service requirements are received from the mobile terminal (Step ST4), an application program for processing the received images is started (Step ST5). By using the launched program, character strings included in the received images are recognized, and text is obtained (Step ST6). Then, the service specified by the mobile terminal is performed. In this case, the obtained text is translated because the translating service has been specified (Step ST7). The result of the translation process is sent to the mobile terminal (Step ST8).

Next, on the mobile terminal side, the result of the process sent from the server is received (Step ST9). The content of the received processing result, namely, the translated text, is displayed on a display device of the mobile terminal (Step ST10).

Through the above process, the result of the translation of character strings included in the images photographed by the camera of the mobile terminal can be obtained.

As described above, the conventional system obtains the result of the translation of character strings in the images by translating the character strings (text), which is the result of the recognition of character strings in the images. However, the resolution of the images that are photographed by the camera of the mobile terminal is lower than that of images read with a scanner whose recognizing target is aimed by a general-use OCR (optical character reader); accordingly, the image quality is poor. Moreover, although this system is presumably used overseas in such a way that character strings on a signboard written in a foreign language are photographed and translated into a mother tongue, the character strings on the signboard usually include ornamental characters. With respect to character strings or ornamental characters in low-quality images, the performance of the current character recognizing system is low, and such characters are likely to be misrecognized. Therefore, there is a problem in that it is difficult to obtain correct results, even if the text obtained through the character recognizing process is translated intact.

Furthermore, there are problems in that when a number of character strings is translated at one time, the user must repeat operations a number of times, for shifting camera view onto character strings to be translated and for pressing a shutter, which creates complex tasks for the user. Moreover, because the resolution of the images photographed by the camera built in the mobile terminal is low, long character strings or text cannot be included in one frame of images. On the other hand, if the user photographs a wider view by, for example, pulling back the camera, the long character strings can be included in one frame of images; however, the number of pixels for displaying each character becomes smaller, and as a result, the character recognition ratio may be decreased. Therefore, there is a problem in that a length of character strings that can be translated is limited.

Furthermore, when images photographed by the mobile terminal are sent to a server, there is a problem in that it takes a long time to transmit data through a telephone line, because the data volume is large. Additionally, in the conventional system, the character recognition and translation processes of the server are deemed to cover general terms; however, in this case, there are problems in that it is difficult to obtain sufficient character recognition and translation performances with respect to particular professional terms such as names of local dishes written on a menu and names of diseases written on a medical record. Moreover, if this type of a system is used, for example, in overseas travel, it is assumed that the system is required not only to translate character strings written in other languages into its own language, but also to translate inputted text written in its own language into other languages.

The present invention is provided in order to solve the above-described problems, and aims at obtaining highly convenient mobile-terminal-type translation systems, mobile terminals, and servers for translation.

### DISCLOSURE OF INVENTION

A mobile-terminal-type translating system relating to a first aspect of the invention comprises a mobile terminal and a server for exchanging data with the mobile terminal; the mobile terminal includes an image photographing unit, an image buffer for storing images photographed by the image photographing unit, an input key unit for inputting keywords, a process instructing unit for specifying types of processing services that are requested of the server, a data sending unit for sending data to the server, in which the data includes the images stored in the image buffer or keywords inputted through the input key unit, a specified type of processing service, and information characterizing the mobile terminal, a result receiving unit for receiving translation results translated in the server, and a display unit for displaying the received translation results; and the server includes a data receiving unit for receiving said data, having been sent from the mobile terminal, an in-image character string recognizing and translating unit, for selecting a plurality of character strings with respect to a character string included in the received images, translating the plurality of selected character strings, and generating results of translating each of the character strings, a text translating unit for generating relevant text with respect to the received keywords, translating the generated relevant text, and generating a translation result, a process control unit for switching, according to the specified type of processing service, included in the received data, between processing by the in-image character string recognizing and translating unit, and processing by the text translating unit, and a result sending unit for sending, according to the characterizing information, to the mobile terminal the translation result generated by the in-image character string recognizing and translating unit or by the text translating unit.

A mobile-terminal-type translating system relating to a second aspect of the invention comprises a mobile terminal and a server for exchanging data with the mobile terminal; the mobile terminal includes an image photographing unit, an image buffer for storing images photographed by the image photographing unit, a process instructing unit for instructing processing services that are requested of the server, a data sending unit for sending data to the server, in which the data includes the images stored in the image buffer, an instruction for executing the processing service, and information characterizing the mobile terminal, a result receiving unit for receiving a translation results translated in the server, and a display unit for displaying the received translation results; and the server includes a data receiving unit for receiving said data, having been sent from the mobile terminal, an in-image character string recognizing and translating unit, for selecting a plurality of character strings with respect to a character string included in the received images, translating the plurality of selected character strings, and generating results of translating each of the character strings, a process control unit for operating the recognizing and translating unit according to a processing service instruction included in the received data, and a result sending unit for sending, according to the characterizing information, to the mobile terminal the generated translation result.

A mobile-terminal-type translating system relating to a third aspect of the invention comprises a mobile terminal and a server for exchanging data with the mobile terminal; the mobile terminal includes an input key unit for inputting keywords, a process instructing unit for instructing processing services that are requested of the server, a data sending unit for sending data to the server, in which the data includes keywords inputted through the input key unit, an instruction for executing the processing service, and information characterizing the mobile terminal, a result receiving unit for receiving translation results translated in the server, and a display unit for displaying the received translation result; and the server includes a data receiving unit for receiving said data, having been sent from the mobile terminal, a text translating unit for generating relevant text with respect to the keywords included in the received data, translating the generated relevant text, and generating the translation result, a process control unit for operating the text translating unit according to a processing service instruction, included in the received data, and a result sending unit for sending, according to the characterizing information, to the mobile terminal the generated translation result.

A mobile-terminal-type translating system relating to a fourth aspect of the invention comprises an in-image character-string recognizing and translating unit of the server which includes an in-image character-string recognizing unit for recognizing under plural differing conditions a character string in an image, to generate a plurality of character-string recognition results; and an in-image character-string translating unit for generating a plurality of translation results in which each of the generated plurality of character-string recognition results is translated.

In a mobile-terminal-type translating system relating to a fifth aspect of the invention, the in-image character-string recognizing and translating unit of the server further comprises; an in-image character-string recognizing unit for recognizing under plural differing conditions a character string in an image, to generate a plurality of character-string recognition results, and for generating similar character strings, by using a language dictionary, whose spellings are similar to those of the plurality of character-string recognition results; and an in-image character-string translating unit for generating a plurality of translation results by translating both the generated character-string recognition results and the similar character strings.

In a mobile-terminal-type translating system relating to a sixth aspect of the invention, the text translating unit of the server further comprises; a relevant text generating unit for generating a plurality of text items closely relating to the received keywords by referring to a relevant text dictionary according to the received keywords; and a relevant text translating unit for translating the plurality of generated text items to generate translation results.

In a mobile-terminal-type translating system relating to a seventh aspect of the invention, the mobile terminal further comprises a sending-image control unit for sequentially selecting each of images that have been sequentially photographed by the image photographing unit at constant time intervals and stored in the image buffer, and for outputting the images to the data sending unit; the server sequentially generates each of results of translating character strings included in each of the received images and sends the results to the mobile terminal; and the display unit of the mobile terminal displays each translation result each time a translation result is received.

In a mobile-terminal-type translating system relating to a eighth aspect of the invention, with respect to images sequentially read from the image buffer, a transmission control unit of the mobile terminal compares the difference between a newly photographed image and the immediately preceding photographed image, and if the difference is less than a threshold value, selects the newly photographed image and outputs the image to the data sending unit.

In a mobile-terminal-type translating system relating to a ninth aspect of the invention, the server further comprises an image integrating unit for combining a plurality of sequentially received images to generate one composite image frame, and the in-image character-string recognizing and translating unit generates translation results with respect to character strings included in the generated composite images.

In a mobile-terminal-type translating system relating to a tenth aspect of the invention, the mobile terminal comprises a GPS unit for obtaining information on the present position of the mobile terminal and adds the positional information to data to be sent to the server; the server includes map data that includes information on the position of different facilities; and the process control unit of the server identifies the facility where the mobile terminal user is at present, by referring to the map data based on the received present positional information, and replaces various dictionaries used in the server with specialized dictionaries with respect to the identified facility.

In a mobile-terminal-type translating system relating to a eleventh aspect of the invention, the process instructing unit of the mobile terminal is configured such that specialized dictionary categories can be designated by a user, and information on a designated specialized dictionary category is added to data to be sent to the server; and the process control unit of the server replaces various dictionaries used in the server with specialized dictionaries according to a received specialized dictionary category.

In a mobile-terminal-type translating system relating to a twelfth aspect of the invention, the mobile terminal further comprises an image preprocessing unit for generating binary encoded preprocessed images so as to separate character strings and backgrounds from color images or gray-scale images, and storing the images into the image buffer, in which the mobile terminal sends the preprocessed images to the server, and obtains a translation result.

In a mobile-terminal-type translating system relating to a thirteenth aspect of the invention, the mobile terminal is configured such that, when noise is included in the preprocessed images, the terminal can designate through key inputting a noise-removal target area surrounding the noise; and the image preprocessing unit edits the preprocessed images by converting black pixels in the noise-removal target area into white pixels.

A mobile terminal relating to a fourteenth aspect of invention exchanges data with a server that carries out translation process and comprises: an image photographing unit; an image buffer for storing images photographed by the image photographing unit; an input key unit for inputting keywords; a process instructing unit for specifying types of processing services that are requested of the server, a data sending unit for sending data to the server, in which the data includes the images stored in the image buffer or inputted keywords, a specified type of processing service, and information characterizing the mobile terminal; a result receiving unit for receiving character strings recognized, and translation results translated, in the server; and a display unit for displaying the received translation results.

A mobile terminal relating to a fifteenth aspect of invention exchanges data with a server that carries out translation process and comprises: an image photographing unit; an image buffer for storing images photographed by the image photographing unit; a process instructing unit for instructing processing services that are requested of the server; a data sending unit for sending data to the server, in which the data includes the images stored in the image buffer, the instruction for executing the processing services, and information characterizing the mobile terminal; a result receiving unit for receiving character strings recognized, and translation results translated, in the server; and a display unit for displaying the received translation results.

A mobile terminal relating to a sixteenth aspect of invention exchanges data with a server that carries out translation process and comprises: an input key unit for inputting keywords; a process instructing unit for instructing processing services that are requested of the server; a data sending unit for sending data to the server, in which the data includes the inputted keywords, instruction for executing the processing services, and information characterizing the mobile terminal; a result receiving unit for receiving translation results translated in the server; and a display unit for displaying the received translation results.

A mobile terminal relating to a seventeenth aspect of invention further comprises a sending-image control unit for sequentially selecting each of images that have been sequentially photographed by the image photographing unit at constant time intervals and stored in the image buffer, and for outputting the images to the data sending unit, in which the displaying unit sequentially displays each result of translating character strings included in each image sequentially received from the server.

In a mobile terminal relating to an eighteenth aspect of the invention, with respect to images are sequentially read from the image buffer, a transmission control unit compares the difference between a newly photographed image and the immediately preceding photographed image, and if the difference is less than a threshold value, selects the newly photographed image and outputs the image to the data sending unit.

A mobile terminal relating to a nineteenth aspect of the invention, further comprises a GPS unit for using GPS functions to obtain information on the present position of the mobile terminal, and for adding the information to data to be sent to the server.

In a mobile terminal relating to a twentieth aspect of the invention, the process instructing unit is configured such that specialized dictionary categories can be designated by a user, and information on a designated special dictionary category is added to data to be sent to the server.

A mobile terminal relating to a twenty-first aspect of the invention, further comprises an image preprocessing unit for generating binary encoded preprocessed images so as to separate character strings and backgrounds from color images or gray-scale images stored in the image buffer, and storing the images into the image buffer, in which the preprocessed images are read from the image buffer and sent to the server enabling to obtain a translation result.

In a mobile terminal relating to a twenty-second aspect of the invention, the mobile terminal is configured such that, when noise is included in the preprocessed images, the terminal can designate through key inputting a noise-removal target area surrounding the noise; and the image preprocessing unit edits the preprocessed images by converting black pixels in the noise-removing area into white pixels.

A server relating to a twenty-third aspect of the invention exchanges data with a mobile terminal and comprises: a data receiving unit for receiving data that includes images, having been sent from the mobile terminal or key-inputted keywords, a specified type of processing service, and information characterizing the mobile terminal; an in-image character string recognizing and translating unit, for selecting a plurality of character strings with respect to a character string included in the received images, translating the plurality of selected character strings, and generating respective results of translating the character strings; a text translating unit for generating relevant text with respect to the keywords, and translating the relevant text so as to generate a translation result; a process control unit for switching, according to the specified type of processing service, between processing by the in-image character-string recognizing and translating unit, and processing by the text translating unit; and a result sending unit for, according to the correlating information, sending to the mobile terminal the translation result generated in the in-image character-string recognizing and translating unit or in the text translating unit.

A server relating to a twenty-fourth aspect of the invention exchanges data with a mobile terminal and comprises: a data receiving unit for receiving data that includes images, having been sent from the mobile terminal, an instruction for executing the processing service, and information characterizing the mobile terminal; an in-image character string recognizing and translating unit, for selecting a plurality of character strings with respect to a character string included in the received images, translating the plurality of selected character strings, and generating respective results of translating the character strings; a process control unit for operating the recognizing and translating unit according to a processing service instruction included in the received data; a result sending unit for sending, according to the characterizing information, to the mobile terminal the translation result generated in the in-image character-string recognizing and translating unit or in the text translating unit.

A server relating to a twenty-fifth aspect of the invention exchanges data with a mobile terminal and comprises: a data receiving unit for receiving data that includes inputted keywords, an instruction for executing the processing service, and information characterizing the mobile terminal; a text translating unit for generating relevant text with respect to the keywords, translating the generated relevant text, and generating a translation result; a process control unit for operating the text translating unit according to the processing service instruction included in the received data; and a result sending unit for sending, according to the characterizing information, to the mobile terminal the translation result generated in the text translating unit.

In a server relating to a twenty-sixth aspect of the invention, the in-image character string recognizing and translating unit further comprises: an in-image character-string recognizing unit for recognizing under plural differing conditions a character string in an image, to generate a plurality of character-string recognition results; and an in-image character-string translating unit for generating a plurality of translation results in which each of the generated plurality of character-string recognition results is translated.

In a server relating to a twenty-seventh aspect of the invention, the in-image character-string recognizing and translating unit of the server further comprises: an in-image character-string recognizing unit for recognizing under plural differing conditions a character string in an image, to generate a plurality of character-string recognition results, and for generating similar character strings, by using a language dictionary, whose spellings are similar to those of the plurality of character-string recognition results; and an in-image character-string translating unit for generating a plurality of translation results by translating both the generated character-string recognition results and the similar character strings.

In a server relating to a twenty-eighth aspect of the invention, the text translating unit further comprises; a relevant text generating unit for referring to a relevant text dictionary according to a keyword inputted through an input key unit and generating a plurality of text items closely relating to the keyword, and a relevant text translating unit for translating the plurality of generated text items to generate translation results.

A server relating to a twenty-ninth aspect of the invention further comprises an image integrating unit for combining a plurality of sequentially received images to generate one frame of composite images; in which the in-image character-string recognizing and translating unit generates translation results relating to character strings included in the generated composite images.

A server relating to a thirtieth aspect of the invention further comprises map data that stores information on the position of different facilities; in which the process control unit of the server identifies the facility where the mobile terminal user is at present, by referring to the map data based on the received present positional information, and replaces various dictionaries used in the server with specialized dictionaries with respect to the identified facility.

In a server relating to a thirty-first aspect of the invention the process control unit replaces various dictionaries used in the server with specialized dictionaries according to a received specialized dictionary category.

### BRIEF DESCRIPTION OF DRAWINGS

FIG. 1 is a block diagram illustrating a mobile-terminal-type translation system according to Embodiment 1 of the invention;

FIG. 2 is an illustration illustrating a situation in which images are photographed, according to Embodiment 1 of the invention;

FIG. 3 is a flow chart illustrating a processing procedure of an in-image character string recognizing unit according to Embodiment 1 of the invention;

FIG. 4 is an illustration illustrating an operational example in the in-image character string recognizing unit according to Embodiment 1 of the invention;

FIG. 5 is an illustration illustrating an operational example in an error-including character strings recognition process, according to Embodiment 1 of the invention;

FIG. 6 is an illustration illustrating an operational example in an in-image character string translating unit according to Embodiment 1 of the invention;

FIG. 7 is an illustration illustrating an operational example in a translation result generating unit for in-image character strings according to Embodiment 1 of the invention;

FIG. 8 is an illustration illustrating a display example of a result of translation of in-image character strings according to Embodiment 1 of the invention;

FIG. 9 is an illustration illustrating a display example of inputting keywords according to Embodiment 1 of the invention;

FIG. 10 is an illustration illustrating a structure of a related-text dictionary according to Embodiment 1 of the invention;

FIG. 11 is an illustration illustrating an operational example in a related-text translating unit according to Embodiment 1 of the invention;

FIG. 12 is an illustration illustrating a result of translation of related-text according to Embodiment 1 of the invention;

FIG. 13 is an illustration illustrating a display example of the result of translation of related-text according to Embodiment 1 of the invention;

FIG. 14 is a block diagram illustrating a mobile-terminal-type translation system according to Embodiment 2 of the invention;

FIG. 15 is an illustration illustrating a situation in which images are photographed, according to Embodiment 2 and Embodiment 3 of the invention;

FIG. 16 is an illustration illustrating images continuously photographed according to Embodiment 2 and Embodiment 3 of the invention;

FIG. 17 is an illustration illustrating an operation of an image sending control unit according to Embodiment 2 of the invention;

FIG. 18 is a block diagram illustrating a mobile-terminal-type translation system configuration according to Embodiment 3 of the invention;

FIG. 19 is an illustration illustrating an operation of an image integration unit according to Embodiment 3 of the invention;

FIG. 20 is a block diagram illustrating a mobile-terminal-type translation system according to Embodiment 4 of the invention;

FIG. 21 is an illustration illustrating an example of selecting a recognition condition according to Embodiment 4 of the invention;

FIG. 22 is a block diagram illustrating a mobile-terminal-type translation system according to Embodiment 5 of the invention;

FIG. 23 is an illustration illustrating an operation of an image pre-processing unit according to Embodiment 5 of the invention;

FIG. 24 is an illustration illustrating an image correction process according to Embodiment 5 of the invention; and

FIG. 25 is a flow chart illustrating a processing procedure of a mobile-terminal-type image processing system according to a conventional art.

### BEST MODE FOR CARRYING OUT THE INVENTION

### Embodiment 1

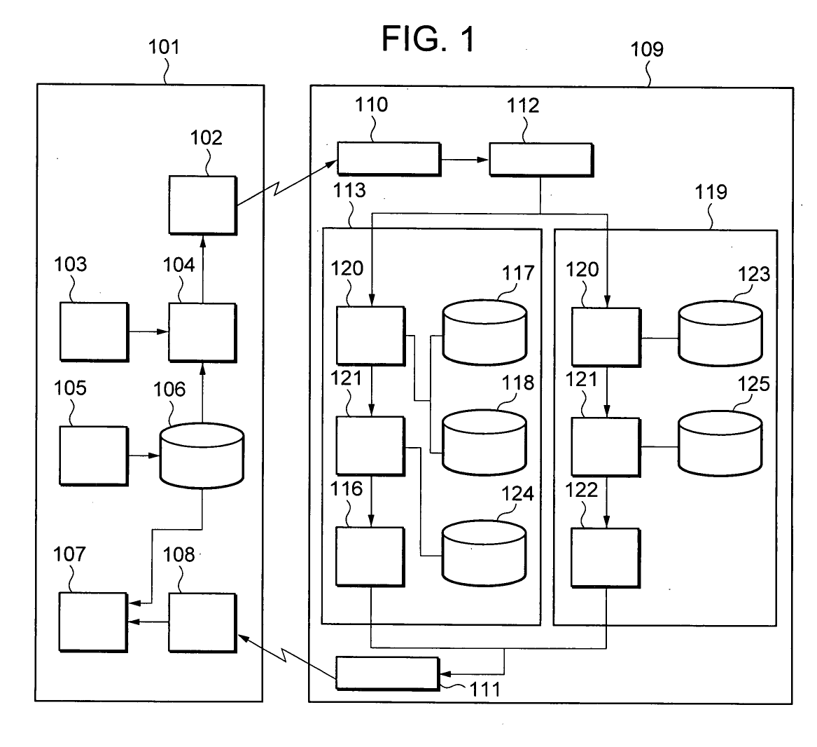

FIG. 1 is a block diagram illustrating a mobile-terminal-type translation system according to Embodiment 1 of the invention. In FIG. 1, “101” is a mobile terminal, “102” is a data sending unit, “103” is a input key unit, “104” is a process instructing unit, “105” is an image photographing unit, “106” is an image buffer, “107” is a displaying unit, “108” is a result receiving unit, “109” is a server, “110” is a data receiving unit, “111” is a result sending unit, “112” is a process control unit, “113” is an in-image character string recognizing and translating unit, and “119” is a text translating unit. In the in-image character string recognizing and translating unit 113, “114” is an in-image character string recognizing unit, “115” is an in-image character string translating unit, “116” is a translation result generating unit for in-image character strings, “117” is a recognition dictionary, “118” is a language dictionary, and “124” is a first translation dictionary. In the text translating unit 119, “120” is a related-text generating unit, “121” is a related-text translating unit, “122” is a translation result generating unit for related-text, “123” is a related-text dictionary, and “125” is a second translation dictionary.

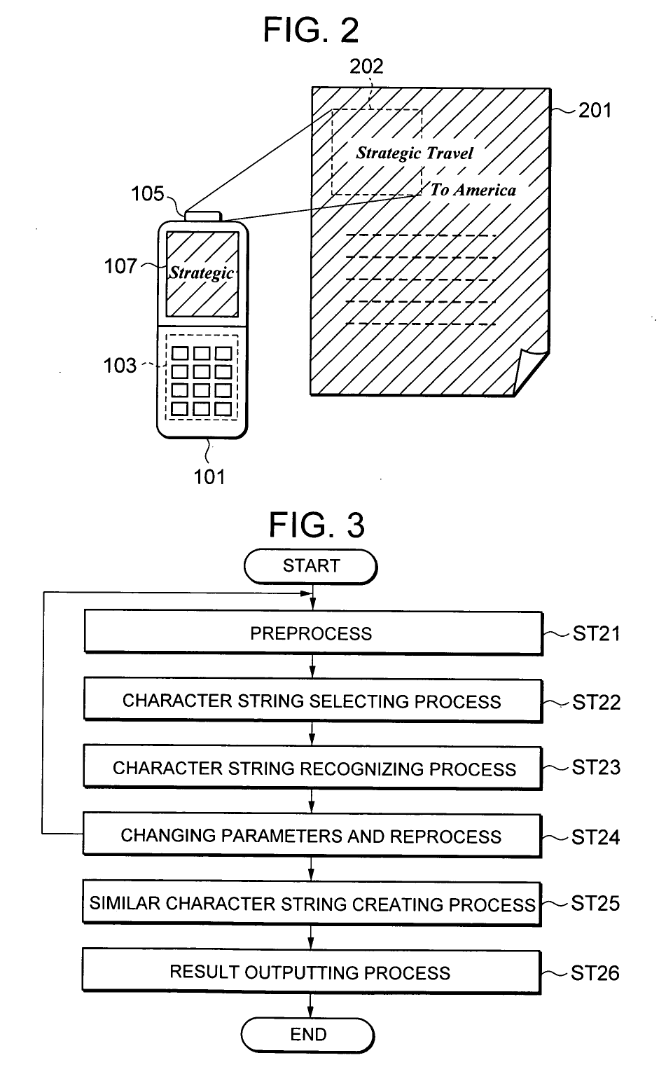

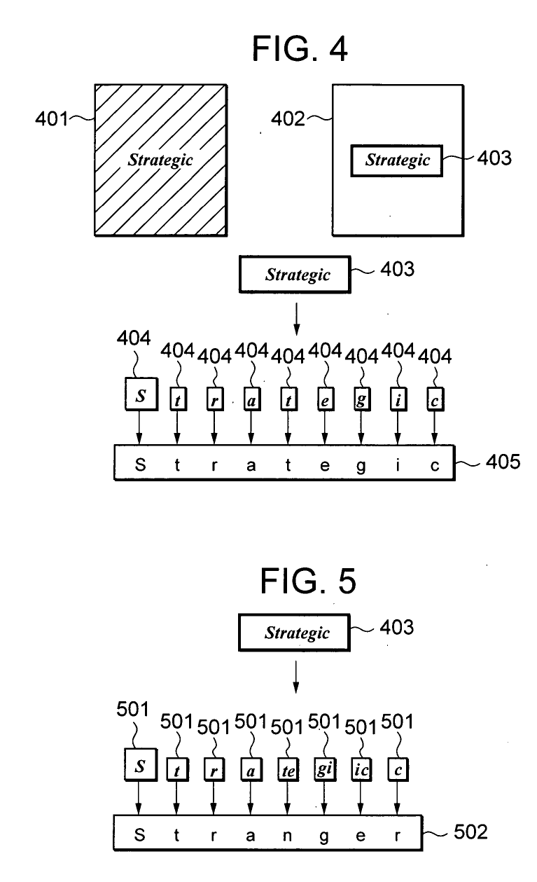

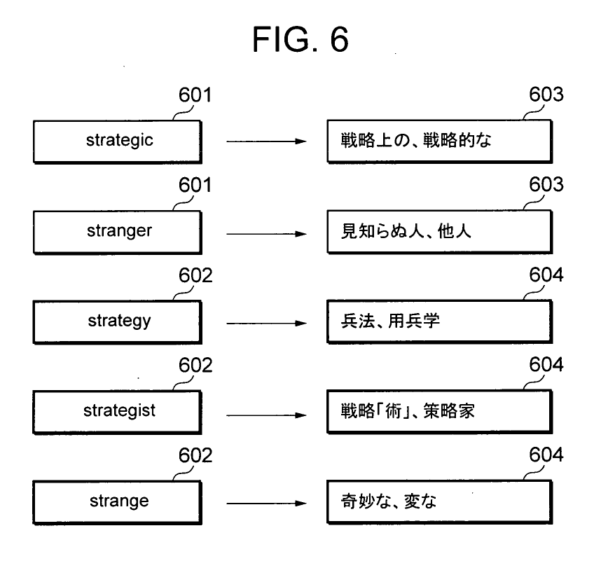

FIG. 2 is an illustration illustrating a situation in which images are photographed. In FIG. 2, “201” is a text, and “202” is a camera view. FIG. 3 is a flow chart illustrating a processing procedure of an in-image character string recognizing unit. FIG. 4 is an illustration illustrating an operational example in the in-image character string recognizing unit, “401” is a photographed image, “402” is a preprocessed image, “403” is an extracted character string, “404” are cut-out character patterns, and “405” is the character-strings-recognition result. FIG. 5 is an illustration illustrating an operational example in a character-strings-recognition process in which errors are included, “501” are cut-out character patterns, and “502” is the error-including character-strings-recognition result. FIG. 6 is an illustration illustrating an operational example in an in-image character string translating unit, “601” are character-string-recognition results, “602” are similar character strings, “603” are results of translating the character-string recognition results 601, and “604” are results of translating the similar character strings 602.

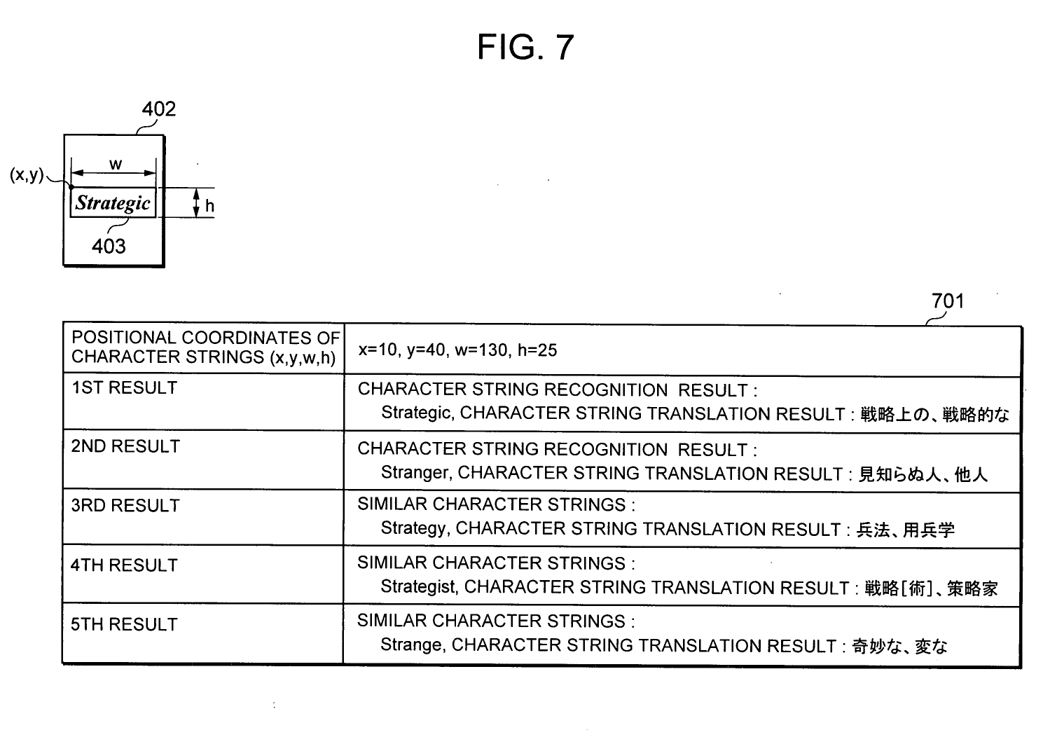

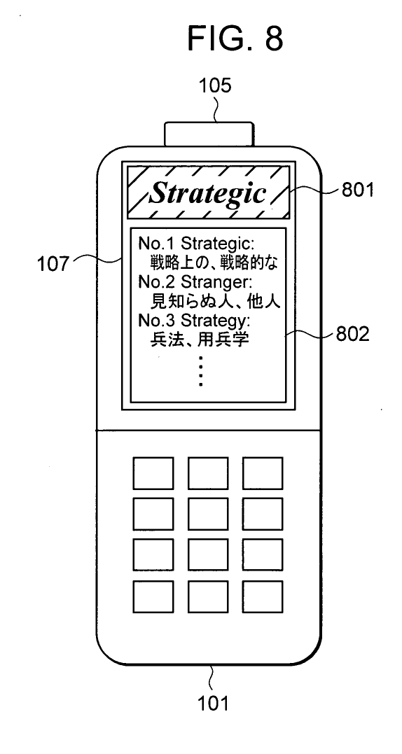

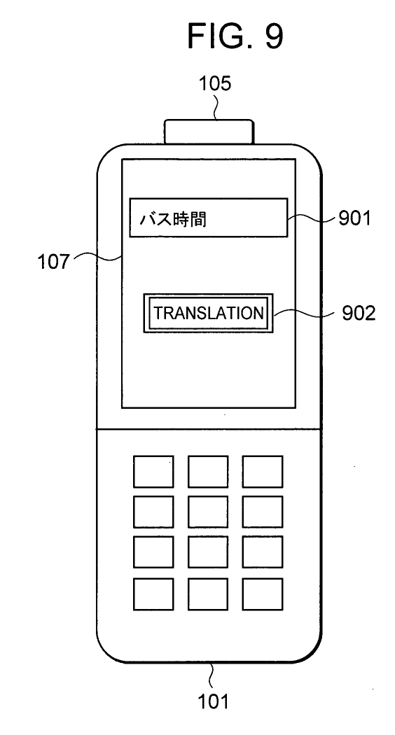

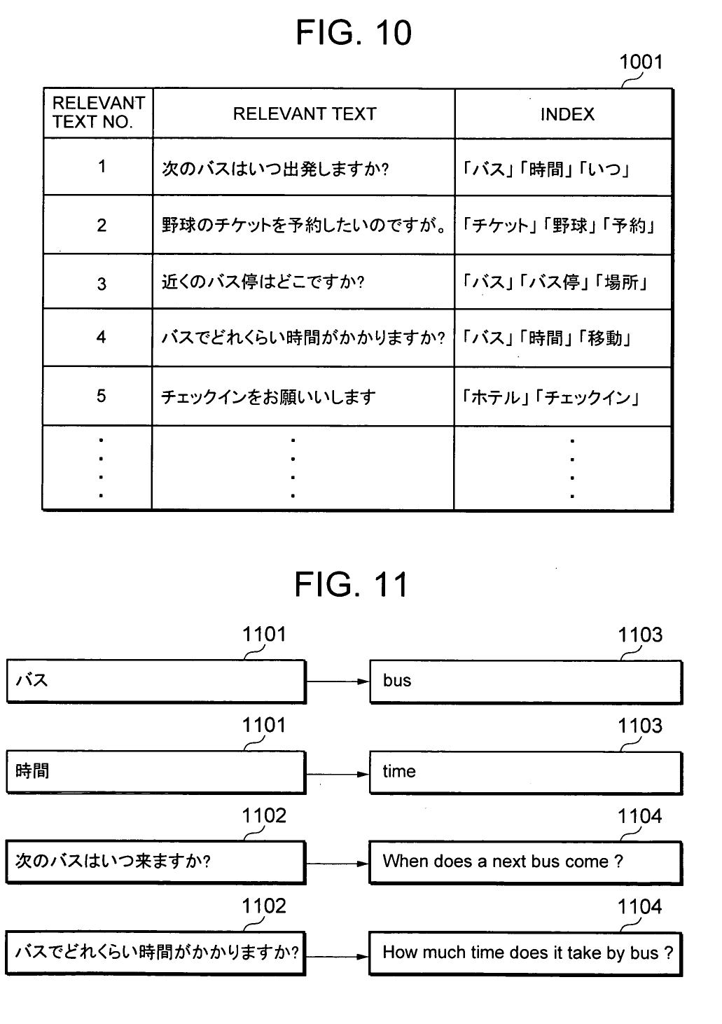

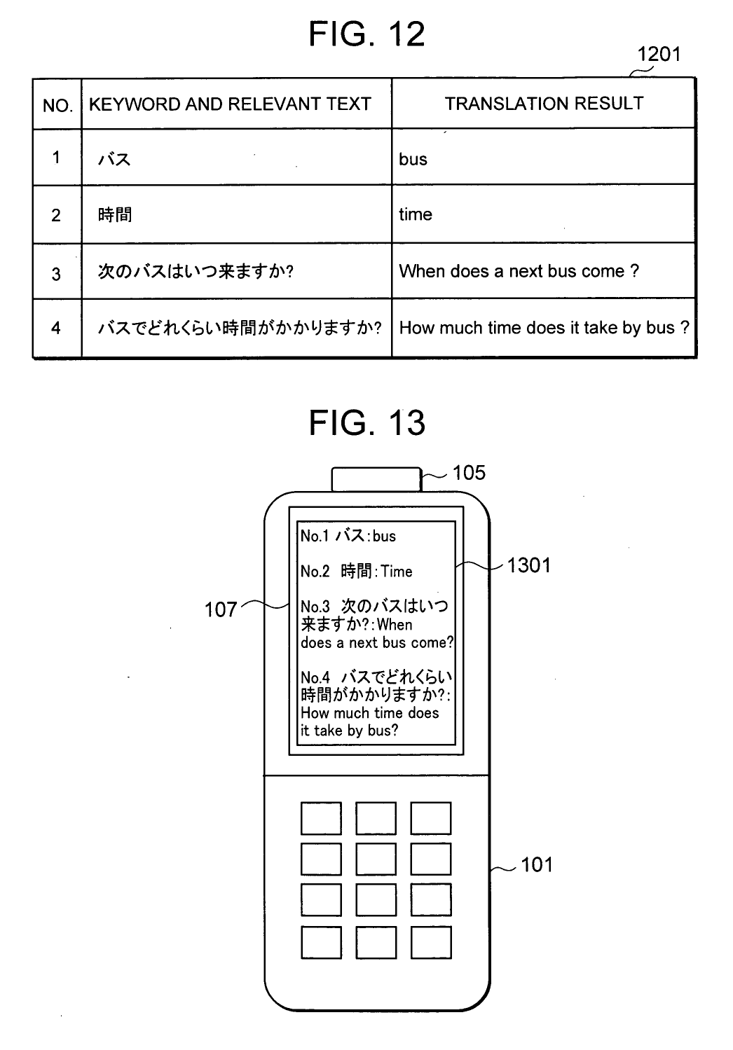

FIG. 7 is an illustration illustrating an operation of a translation result generating unit for in-image character strings. In FIG. 7, “701” is an example of a result of translation of in-image character strings. FIG. 8 is an illustration illustrating a display example of the result of translation of in-image character strings. In FIG. 8, “801” is an image of recognized character strings, and “802” is an image of a result of translation of the character strings in the images. FIG. 9 is an illustration illustrating a display example of inputting a keyword. In FIG. 9, “901” is a keyword inputting area, and “902” is a display of a translation button. FIG. 10 is an illustration illustrating a structure of a related-text dictionary. In FIG. 10, “1001” is related-text dictionary data. FIG. 11 is an illustration illustrating an operational example in a related-text translating unit. In FIG. 11, “1101” is an inputted text, “1102” is a related-text, and “1103” and “1104” are results of translation of the character strings. FIG. 12 is an illustration illustrating an operational example in a related-text translation result generating unit. In FIG. 12, “1201” is an outputted result of the related-text translation result generating unit. FIG. 13 is an illustration illustrating a display example of the related-text translation result. In FIG. 13, “1301” is a result of translation.

Next, the operations are described.

The translation system includes the mobile terminal 101 and the server 109. The mobile terminal 101 has a transmission function for sending/receiving data to/from the server 109, asks the server 109 to perform a translation process, and can receive and display the processing result. The communication between the mobile terminal 101 and the server 109 is processed by a method that sends and receives data by means of a wireless, infrared, or cable communication system. Here, the server 109 has two service items. One of the service items is translating character strings included in images photographed by the image photographing unit 105 of the mobile terminal; hereafter, this service is referred to as the “recognition service for in-image character strings”. The other service is translating text contents that have been inputted by the input key unit 103 of the mobile terminal; hereafter, this service is referred to as the “text translation service”.

The operations of the recognition and translation service for in-image character strings are described.

A user photographs an image, including character strings, by the image photographing unit 105 of the mobile terminal 101. For example, as described in FIG. 2, the mobile terminal 101 is moved close to the text 201, and an area of the camera view 202 is photographed as one frame of images. The image photographing unit 105 is a camera having, for example, a CCD or a CMOS sensor that has an image photographing function, and that is attached to or connected with the mobile terminal 101. A photographed image is a color image or a gray-scale image. Moreover, a photographed object is a part of text or characters in a scene such as a signboard or a guide plate. An image photographed by the image photographing unit 105 is then stored in the image buffer 106.

Next, the process instructing unit 104 specifies a type of process service that is processed by the server 109. The service type is specified by a user inputting from the input key unit 103 or automatically by using a default setting. Here, recognition and translation of character strings in images is specified as a type of process service. When the process service is specified by the process instructing unit 104, the data sending unit 102 sends to the server 109 data that includes images stored in the image buffer 106, the type of process service specified by the process instructing unit 104, and related information (for example, a model code).

When the data receiving unit 110 receives data from the data sending unit 102 of the mobile terminal 101, the data is inputted into the process control unit 112 in the server 109.

The process control unit 112 switches over subsequent process contents according to the specified process service type. Here, the in-image character string recognizing and translating unit 113 is controllingly operated, because the service for recognizing and translating character strings in images has been specified as described above. If the text translation service is specified in the process instructing unit 104, the text translating unit 119 is controllingly operated.

In the unit 113 for recognizing and translating character strings in images, the in-image character string recognizing unit 114 operates first, and recognizes character strings in a data image sent from the mobile terminal 101. A practical operation of the recognizing unit 114 will be described according to the processing procedure in FIG. 3.

At first, images sent from the mobile terminal 101 are preprocessed (Step ST21), and preprocessed images, in which the character strings and the background in the image have been separated, are made. For example, when a photographed color image 401 illustrated in FIG. 4 is sent from the mobile terminal 101, a black and white preprocessed image 402 is obtained in which the background is made white and the character strings are made black, by preprocessing the photographed image 401. The method to realize preprocessing of this kind is disclosed in the article “Text extraction from color documents-clustering approaches in three and four dimensions”, T. Perroud, K. Sobottka, H. Bunke, international Conference on Document Analysis and Recognition (2001).

Next, extracted character strings are obtained by extracting them from the preprocessed image (Step ST22). For example, the extracted character string 403 is extracted from the preprocessed image 402 in FIG. 4. A system already realized in a conventional OCR is used in a process of this kind for extracting character strings from a black and white image. Character contents of the extracted character strings in Step ST22 are recognized (Step ST23). As a character recognizing method, a translating method is widely known in which one single character string is extracted from the character pattern and the extracted character string is translated into a character code by referring to the recognition dictionary 117. Here, when the extracted pattern is translated into the character code, a character strings recognition result having high linguistic fidelity can be obtained by referring to the language dictionary 118. This method is popular as well. For example, if this process is applied to the extracted character string 403 in FIG. 4, the character pattern 404 in which characters are cut out one by one is obtained first, and by translating the cut-out character pattern 404 into the character code, the character strings recognition result 405 in which characters are converted into text can be obtained.

Through the above process, a character-strings-recognition result (text) related to character strings in images can be obtained. However, if the resolution of the object image is low, the image quality is poor, or the character strings that are objects to be recognized are ornamental writings, characters are sometimes misrecognized. For example, as described in FIG. 5, a cut-out character pattern 501 is likely to have errors, and consequently, a misrecognized text result 502 may be obtained. In order to cope with the problem above, processes from Step ST21 to ST23 are repeated while changing process parameters, and then a plurality of character recognition results is obtained (Step ST24). As illustrated in FIG. 6, characters “Strategic” and “Stranger” are obtained as two character string recognition results 601 by repeating processes from Step ST21 to ST23 two times while changing processing parameters for an extracted character string 403 in FIG. 4. If a plurality of character recognition results is obtained as described above, a correct character recognition result will probably be included in the results. However, there may be cases in which correct recognition may not be included in the plurality of character string recognition results obtained in Step ST24. Therefore, a plurality of character strings whose spellings are similar to the plurality of character string recognition results obtained in Step ST24, is extracted (Step ST25). For example as described in FIG. 6, three similar character strings 602 are created in which the strings have similar spellings to those from the two character string recognition results 601 obtained in Step ST24.

The in-image character string recognizing unit 114 outputs to the in-image character string translating unit 115 the plurality of character string recognition results obtained in Step ST24 together with the plurality of similar character strings obtained in Step ST25 (Step ST26). Because the plurality of character string recognition results and the plurality of similar character strings corresponding to the character string recognition results are outputted as described above, a correct character recognition result will probably be included in the results. These are the above-described operations of the in-image character string recognizing unit 114.

Next, the in-image character string translating unit 115, referring to the first translation dictionary 124 in which information necessary for translation is stored, translates the plurality of character string recognition results obtained by the in-image character string recognizing unit 114 to obtain the character string recognition results, and then outputs the results to the in-image character string translation result generating unit 116.

The translation process obtains, for example as described in FIG. 6, the character string translation results 603 and 604 that are translated from the character string recognition results 601 that are obtained by the in-image character string recognizing unit 114 and from the similar character strings 602, respectively.

The translation result generating unit 116 for in-image character strings combines the character string recognition results obtained by the in-image character string recognizing unit 114, the similar character strings, and the character string translation results obtained by the in-image character string translating unit 115, and creates the character string translation results in the images as the data to be sent to the mobile terminal 101. For example, a character string recognition result 701 in the images in FIG. 7 has been obtained corresponding to photographed images 401 shown in FIG. 4. This character string recognition result 701 in the images includes positional coordinates of the extracted character string 403 that has been cut out from the preprocessed image 402 (for example, coordinates “x” and “y” of an upper left point of a rectangle surrounding the character strings, and a width “w” and a height “h” of the rectangle surrounding the string rim). Additionally, the result 701 includes the character string recognition results obtained by the in-image character string recognizing unit 114, the similar character strings, and the character string translation results obtained by the in-image character string translating unit 115.

The server 109 sends the result of translation of character strings created by the translation result generating unit 116 for in-image character strings to the mobile terminal 101 via the result sending unit 111.

Here, the data type of the character string recognition result, the similar character strings, and the result of translation of character strings is text or image. For example, if the mobile terminal 101 does not have a function for displaying language characters that constitute the character string recognition result, an image describing the character string recognition result is used as the result of in-image character strings recognition result. Here, a judgment whether or not the mobile terminal 101 has a function for displaying characters of a specific language is made based on related information on the mobile terminal (for example, model code), which is sent from the data sending unit 102 of the mobile terminal 101.

Next, in the mobile terminal 101, the result receiving unit 108 firstly receives the result of translating in-image character strings, which is sent from the result sending unit 111 of the server 109. Next, the displaying unit 107 displays the result of translating character strings, which is included in the photographed images, on the displaying unit 107, based on the photographed images that are stored in the image buffer 106, and the received result of translating in-image character strings. The displaying unit 107 includes a liquid crystal display that can display a character or an image thereon. For example, as illustrated in FIG. 8, a recognized character string image 801 that represents recognized character strings is displayed on the displaying unit 107, and at the same time, the displaying unit displays the image 802 that is the result of translating in-image character strings including the result of recognizing the character strings, the similar character strings, and the result of translating character strings. The above-described operations are an example of service for recognizing and translating in-image character strings.

Next, the operations of the text translation service are described.

On the mobile terminal 101, firstly a user inputs from the input key unit 103 text required to translate. In this case, a keyword relating to the text is inputted, because it takes a long time to input text by a general-use mobile terminal. If a user wants to translate a Japanese text which means, for example, “What time will the next bus depart?”, the user inputs Japanese words which mean “bus” and “time”, as the keywords. FIG. 9 is an example in that the user has inputted the keywords, and the inputted keywords are displayed on the keyword inputting area of the displaying unit 107. If the user clicks the indication for a translation button display 902 by operating the input key unit 103 after having inputted the keywords, a translation process is started.

The process instructing unit 104 specifies a type of process service performed in the server 109. Here, text translation service is specified as the type of process service. Then, the data sending unit 102 sends to the server 901 the keywords that have been inputted into the keyword inputting area 901, the type of the process service that has been specified by the process instructing unit 104, and related information (for example, model code) of the mobile terminal 101.

In the server 109, the data receiving unit 110 receives data that is sent from the sending unit 102 of the mobile terminal 101, and inputs the data into the process control unit 112. The process control unit 112 switches over the subsequent process contents according to the type of the process service that has been specified by the process instructing unit 104. Here, the text translating unit 119 is controllingly operated, because the text translation service is specified by the process instructing unit 104.

In the text translating unit 119, a related-text generating unit 120 operates at first, and text (hereinafter, referred to as “related-text”) analogized from the keywords is created according to the keywords sent from the mobile terminal 101 and the data of the related-text dictionary 123. Here, the related-text dictionary 123 has, for example, as illustrated in FIG. 10, the related-text dictionary data 1001. The related-text dictionary data includes a great deal of stored related-text and its indices. The related-text generating unit 120 compares the indices with keywords sent from the data sending unit 102, reads out the related-text that includes the keyword in the index, from the related-text dictionary 123, and outputs the text into a related-text-translating-unit 121. For example, if the keywords are Japanese words which mean “bus” and “time”, following are outputted from the related-text dictionary data 1001: number-one relevant Japanese text, which means “When will the next bus depart?”, and number-two relevant Japanese text, which means “How long does it take by bus?”

The related-text translating unit 121 translates the keywords sent from the data sending unit 102 and the related-text obtained from the related-text generating unit 120 using the second translation dictionary 125. For example, the unit 121 carries out translating process for input text “1101” that corresponds to the keywords and related-text “1102” in FIG. 11, obtains both results of translating character strings “1103” and “1104”, and outputs the results into a related-text-translation-result generating unit 122. The above-described text translating function has already been realized in general translating software.

The related-text-translation-result generating unit 122 puts the keywords sent from the data sending unit 102 and the related text obtained from the related-text generating unit 120, and the result of translating character strings obtained by the related-text translating unit 121 together, creates the result of translating related-text as the data to be sent to the mobile terminal 101, and outputs the data into the result sending unit 111. The translation result “1201” is illustrated in FIG. 12 as an example. “Keywords and related-text” and corresponding “translation results” are stored in this unit.

The result sending unit 111 sends to the mobile terminal 101, the result of translating related-text created in the related-text-translation result generating unit 122.

Here, data format of the translation result is in text or image. For example, if the mobile terminal 101 does not have a function for displaying characters of the language that constitutes the translation result, images that describe the translation result are used as the related-text-translation result. Here, whether or not the mobile terminal 101 has a function for displaying specified language characters is judged according to related information on the mobile terminal (for example, model code), which is sent from the data sending unit 102 of the mobile terminal 101.

The mobile terminal 101 receives the result of translating related-text with the result receiving unit 108, and feeds the result to the displaying unit 107. The displaying unit 107 displays received contents of the result of translating related-text. For example, as illustrated in FIG. 13, the displaying unit 107 displays the translation result “1301” including text, related-text, and those translation results. Performing the text translation service can be exemplified as described above.

As described above, according to Embodiment 1, an effect of realizing a system that can cope with both translations for in-image character strings and inputted text can be obtained. Because the recognizing and translating service for in-image character strings is configured such that the in-image character string recognizing unit 114 creates a plurality of character recognition results and each of translation results of a plurality of similar character strings, the in-image character string translation unit 115 creates each of translation results corresponding to a plurality of character recognition results and translation results of a plurality of similar character strings, sends the plurality of translation results to the mobile terminal 101, and displays the results on the displaying unit 107, an effect can be obtained, in which translation that has high correct translation ratio even for in-image characters or an ornamental writing that are difficult to recognize, and have low resolution and poor quality. Moreover, because the text translating service is configured such that a plurality of related-text is created from the keywords inputted from the mobile terminal 101, and the translation results are displayed on the displaying unit 107 of the mobile terminal 101, an effect can be obtained, in which not only all text required to translate does not need to be inputted and troublesome work of inputting text can be eliminated, but also the result of translation of text that needs high correct-recognition ratio can be obtained.

### Embodiment 2

Next, a recognizing and translating service for in-image character strings according to another embodiment of the invention will be explained. In the recognizing and translating service for in-image character strings in above Embodiment 1, a user sends the images to the server 109 after having photographed one frame of images with the mobile terminal 101, and obtains the result of translating character strings included in the images. Therefore, when the user translates a number of character strings at one time, the user must repeat a number of times the operations of removing camera view onto required character strings to translate and then pushing a shutter, which causes complex operations to the user. These problems would be solved, if photographing continues automatically at constant intervals after the user has started to photograph, and the photographed images are sequentially translated in the server 109 so as to obtain the result of translation in semi-real time. Embodiment 2 aims to realize this function.

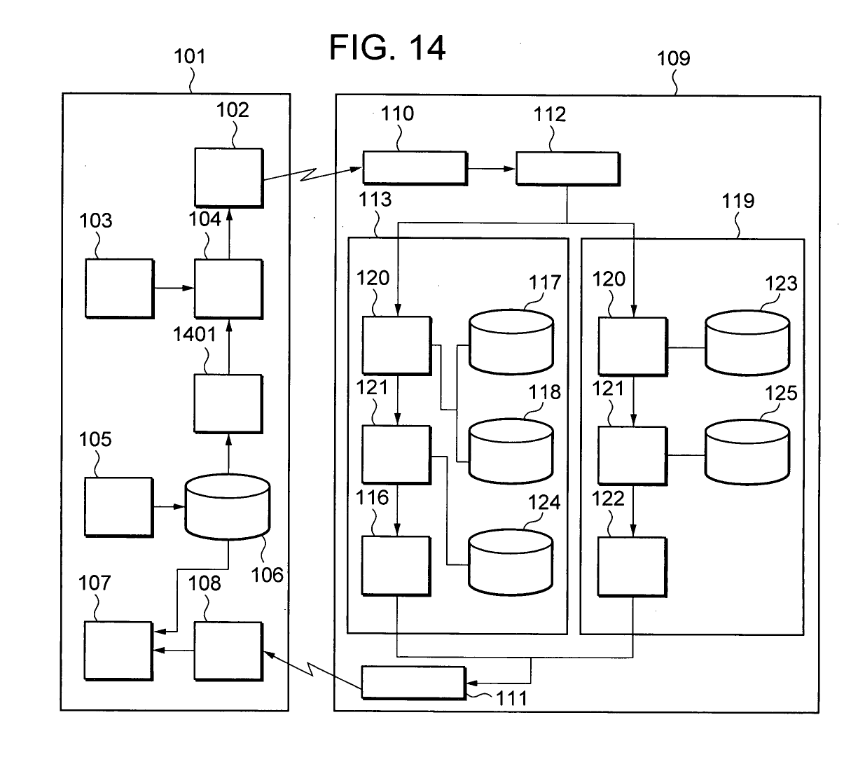

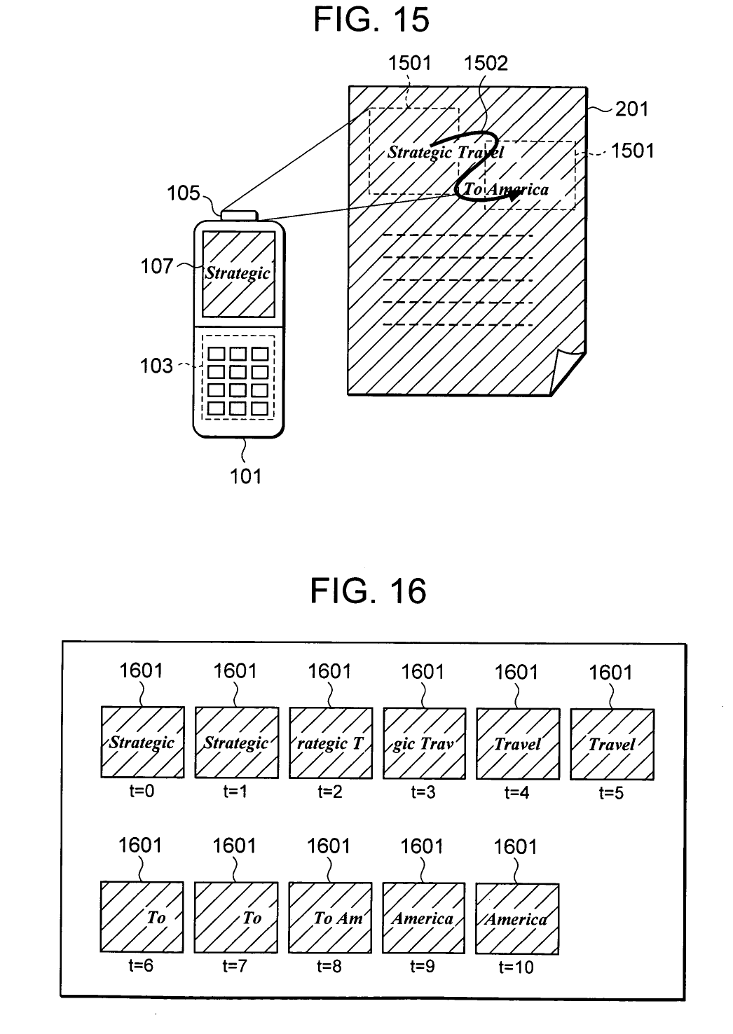

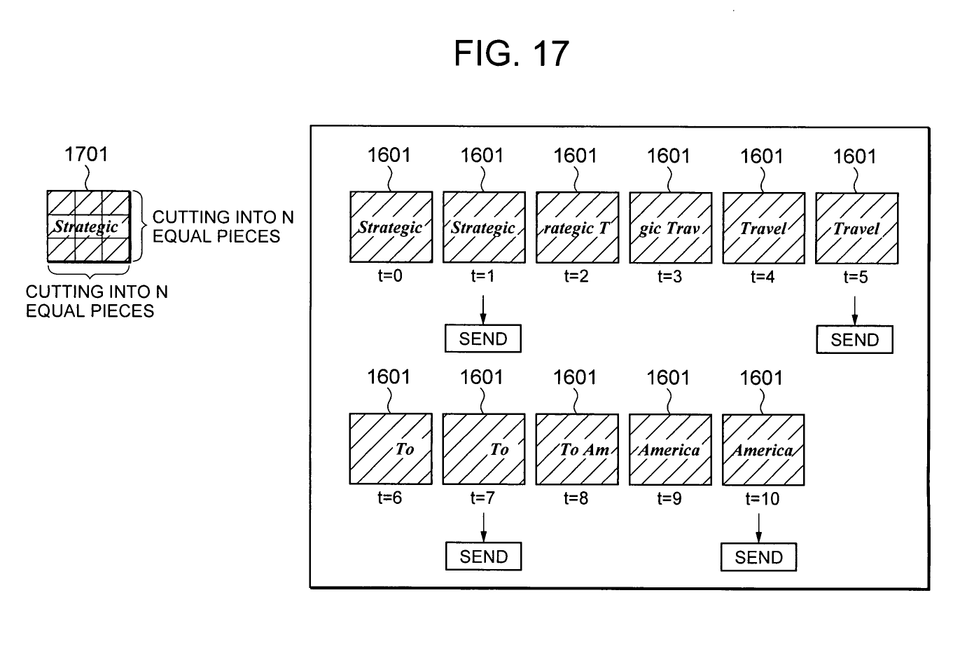

Embodiment 2 will be explained using FIG. 14 through FIG. 17. In each figure, parts that are in common with those in each figure of Embodiment 1 refer to identical reference numerals, and the explanation for the reference numerals is omitted in principle. FIG. 14 is a block diagram illustrating a mobile-terminal-type translation system according to Embodiment 2 of the invention. In FIG. 14, “1401” is a sending-image control unit. FIG. 15 is an illustration illustrating a situation where continuous images are photographed. In FIG. 15, “1501” is a camera view, and “1502” is a trajectory along which the camera view has moved. FIG. 16 is an illustration illustrating an example of images photographed continuously. In FIG. 16, “1601” are images continuously photographed. FIG. 17 is an illustration illustrating an operation of the sending-image control unit. In FIG. 17, “1701” illustrates a segmented area.

Next, the operations are described.

In the mobile terminal 101, the image photographing unit 105 photographs images that include character strings when the recognizing and translating service is processed. Unlike Embodiment 1, the image photographing unit 105 continuously photographs images at constant intervals, once the unit has started photographing images. The images that have been photographed by the image photographing unit 105, are stored in the image buffer 106 for each time. More than one frame of images can be stored in the image buffer 106. Next, the sending-image control unit 1401 firstly selects one frame of images stored in the image buffer 106; in this stage, the unit 1401 selects one frame of images that has been photographed at first. The process instructing unit 104 specifies a type of process service to be performed in the server 109 as with Embodiment 1. Here, the recognition and translation for character strings is specified as the type of process service.

The sending unit 102 sends to the server 109 images selected by the sending-image control unit 1401, the type of process service specified by the process instructing unit 104, and related information (for example, model code).

In the server 109 as in Embodiment 1, character strings included in the images sent from the data sending unit 102 are translated, and the result of translating in-image character strings obtained by the process is sent to the mobile terminal 101. Next, in mobile terminal 101 as with Embodiment 1, the result receiving unit 108 receives the result of translating in-image character strings from the server 109, and displays the result of translation on the displaying unit 107.

Next, in the mobile terminal 101, the sending images control unit 1401 selects other images (the next images photographed after the images having been translated at the moment) stored in the image buffer 106, requests for the recognizing and translating service to the server 109, receives the result of translation, and displays it on the display unit 107. Then, processes are sequentially repeated for remaining stored images in the image buffer 106.

Assume that the camera view 1501 of the mobile terminal 101 is moving along the trajectory of the camera view moving 1502 as in FIG. 15 in order to photograph all text required to translate while the above processes are sequentially repeated eleven photographed images 1601 are obtained as illustrated in FIG. 16. In FIG. 16, each “t” represents the time; “t=0” represents the time when first images is photographed; and “t=10” represents the time when last images is photographed. These photographed images 1601 are sent to the server 109 and sequentially translated according to the photographed sequence, and the result of translation is displayed on the display unit 107 of the mobile terminal 101.

In addition, although the sending-image control unit 1401 is explained to select all images according to the photographed sequence, it will increase in sending data volume and processing volume in the server 109 to select all of images and request the server 109 to recognize and translate in-image character strings. Therefore, it may be possible to limit images to be selected according to other standard. For example, the sending-image control unit 1401 may equally divide by N the longitudinal and lateral sides of an image stored in the image buffer 106 so as to create segmented area 1701 and calculates brightness of each segmented area as described in FIG. 17. Then, the unit 1401 calculates differences of the brightness of each segmented area between a newly photographed image and a photographed image in a-time advance, and if sum of the differences is under a threshold value, selects the new photographed images. Through the above processes, only images photographed at the time when the camera stops moving are selected, and only the images including character strings that a user wants to translate can be sent to the server. In FIG. 17, the photographed images at the time “t” of, for example, 1, 5, 7, and 10, can be selected.

As described above, according to Embodiment 2, if the user starts to photograph, the unit 1401 automatically photographs at constant intervals after that, and the photographed images are sequentially translated in the server 109 side. Therefore, the user needs not to repeat works of moving the camera view along the character strings required to translate and to press the shutter, resulting in reducing troublesome work and in obtaining the translation result in semi-real time. Moreover, because the sending-image control unit 1401 calculates image deviation between a photographed image and a image photographed in a-time advance, selects images whose image deviation is under a threshold level, and sends them to the server 109, the user can obtain the translation result for only images including the character strings that the user want to translate, and consequently an effect of reducing the data sending volume and the processing volume in the server 109 can be obtained.

### Embodiment 3

It is necessary that character strings required to translate is included in one frame of images in the recognizing and translating service for in-image character strings according to above Embodiment 1 and 2. However, because images photographed by a camera of the mobile terminal 101 have low resolution, it is difficult that a long character string or text is included in one frame of images. Therefore, the length of the character strings that can be translated is limited. The problems can be solved by sending from the mobile terminal 101 to the server 109 a plurality of images that includes pieces of character strings or text photographed by the camera, and making a big composite image from a plurality of images, and translating the character strings included in the composite image in the server 109 side. The above-described function is realized by Embodiment 3.

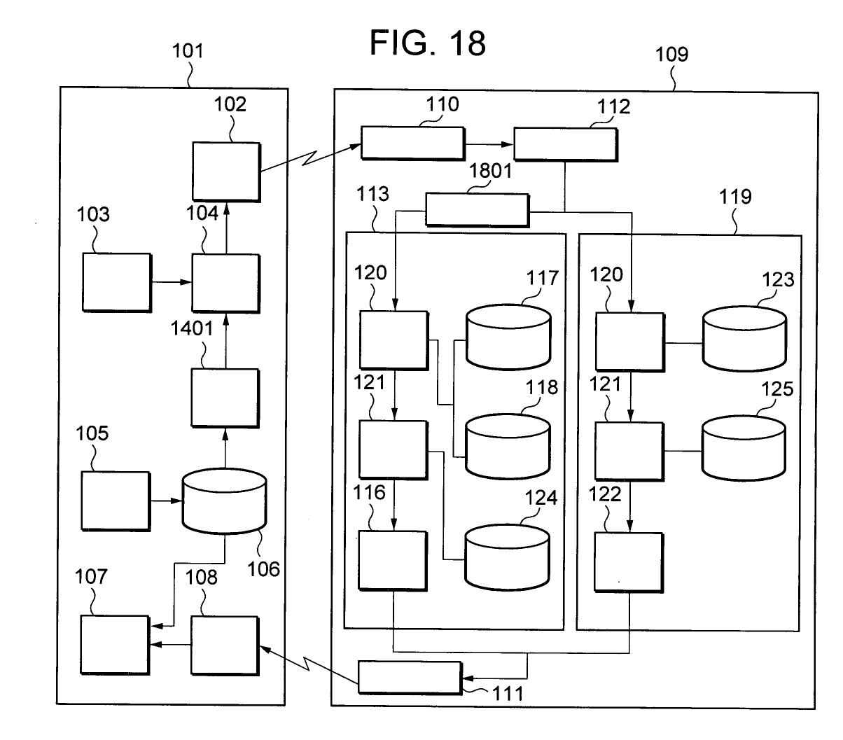

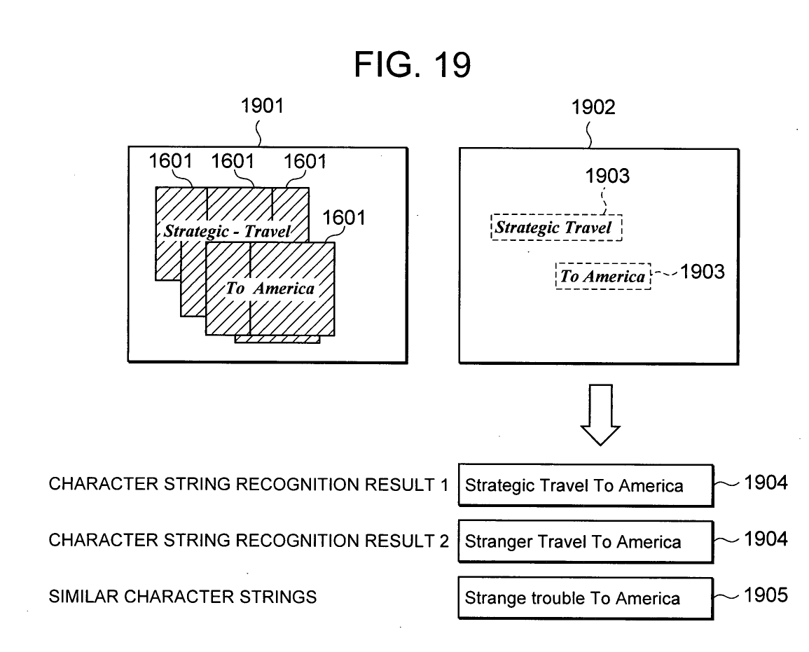

Next, Embodiment 3 of the invention will be explained by using FIG. 15, FIG. 16, FIG. 18, and FIG. 19. In figures, reference numerals that are the same as those in each figures of Embodiments 1 and 2 refer to identical items, and the explanations for those items are omitted in principle. FIG. 18 is a block diagram illustrating a mobile-terminal-type translation system according to Embodiment 3 of the invention. In FIG. 18, “1801” is an image integrating unit. FIG. 19 is an illustration illustrating an operational example in the image integrating unit. In FIG. 19, “1901” is a composite image, “1902” is a preprocessed image related to the composite images, “1903” are extracted character strings, “1904” are character-strings-recognition results, and “1905” is a similar character string.

Next, the operations are described.

When the recognizing and translating service for in-image character strings is processed, in the mobile terminal 101, images are firstly photographed at constant intervals as in Embodiment 2, and the images are stored in the image buffer 106. For example, if the camera view 1501 is moved along the moving trajectory of the camera view 1502 as in FIG. 15, a plurality of photographed images 1601 is stored in the image buffer 106.

Then, the process instructing unit 104 specifies a type of process service carried out in the server 109. Here, the recognizing and translating service for in-image character strings is specified as the processing service, and “making composite images” is specified as a processing condition. The condition is specified by a user through the input key unit 103, or is done automatically using a default. According to the process, the data sending unit 102 sends to the server 109 a plurality of photographed images stored in the image buffer 106, the type of the process service and the processing condition specified by the process instructing unit 104, and the related information (for example, a model code).

In the server 109, the data receiving unit 110 receives data from the data sending unit 102, and the process control unit 112 switches over following processes according to the specified type of the process service. Moreover, in a case where the recognizing and translating service for in-image character strings is specified, the image integrating unit 1801 is operated as well. The image integrating unit 1801 creates a composite image by composing a plurality of received images, when “making composite images” is specified as an execution condition of the process service. For example, composite images 1901 illustrated in FIG. 19 are obtained by composing a plurality of photographed images 1601 illustrated in FIG. 16. As described above, the process for making a big composite image from a plurality of fragmentary images has already been built into commercially available software for digital camera or image processing software; therefore the process can be realized by using these methods.

Next, the in-image character string recognizing unit 114 is operated corresponding to the composite images made by the image integrating unit 1801. The for in-image character string recognizing unit 114 performs the same processes as those in Embodiment 1 and 2. For example, as illustrated in FIG. 19, the composite image 1901 is made from the preprocessed images 1902, and the extracted character strings 1903 are extracted from the preprocessed images 1902. Then, the character-strings-recognition results 1904 and the similar character string 1905 corresponding to the extracted character strings 1903, are obtained. Next, the in-image character string translating unit 115, as with Embodiments 1 and 2, creates each of the results of translating character strings of a plurality of results of recognizing character strings and similar character strings, which has been obtained by the in-image character string recognizing unit 114.

When the result of translating character strings is obtained, the translation result generating unit 116 for in-image character strings creates the result of translating the in-image character strings. In Embodiment 1 and 2, results of recognizing the in-image character strings include the character strings position coordinate, the result of recognizing character strings, the similar character strings, and the result of translating character strings as illustrated in FIG. 7. In Embodiment 3, extracted character strings that are extracted from the composite images, are added to the result of recognizing the in-image character strings too. Next, as with Embodiment 1 and 2, the result of recognizing the in-image character strings, which is made by the translation result generating unit 116 is sent to the mobile terminal 101 from the result sending unit 111.

In the mobile terminal 101, the result receiving unit 108 receives the result of recognizing the in-image character strings sent from the server 109, and sends the result to the display unit 107 for displaying. As a displaying result, the image 801 of recognized character strings extracted from the composite images is displayed, and image 802 of the result of translating character strings in the images, which includes the result of recognizing character strings, the similar character strings, and the result of translating character strings, is displayed as with those illustrated in FIG. 8.

As described above, according to Embodiment 3, an effect can be obtained, in which contents of long character strings or text all of which do not appear in a camera view, can be translated, because, when a plurality of images that includes pieces of the character strings or text photographed by the camera is sent from the mobile terminal 101 to the server 109, the server 109 creates a big composite image by composing these images, and recognizes the character strings included in the composite image, and then extracts and translates them.

### Embodiment 4

In above Embodiment 1 to 3, the character string recognition and translation process of the server is used for general words. However, for example, when names of local dishes in an overseas restaurant are requested to translate, or names of diseases written on a medical record in an overseas hospital are requested to translate, highly professional words must be translated. In these cases however, it is difficult to obtain satisfactory character recognition and translation performance. The problems are solved by replacing various dictionaries that are used for character recognizing and translating processes with appropriate professional word dictionaries according to user's choice or user's present position obtained by GPS (Global Position System) function of a mobile terminal, and by executing the processes. Embodiment 4 aims at solving these problems.

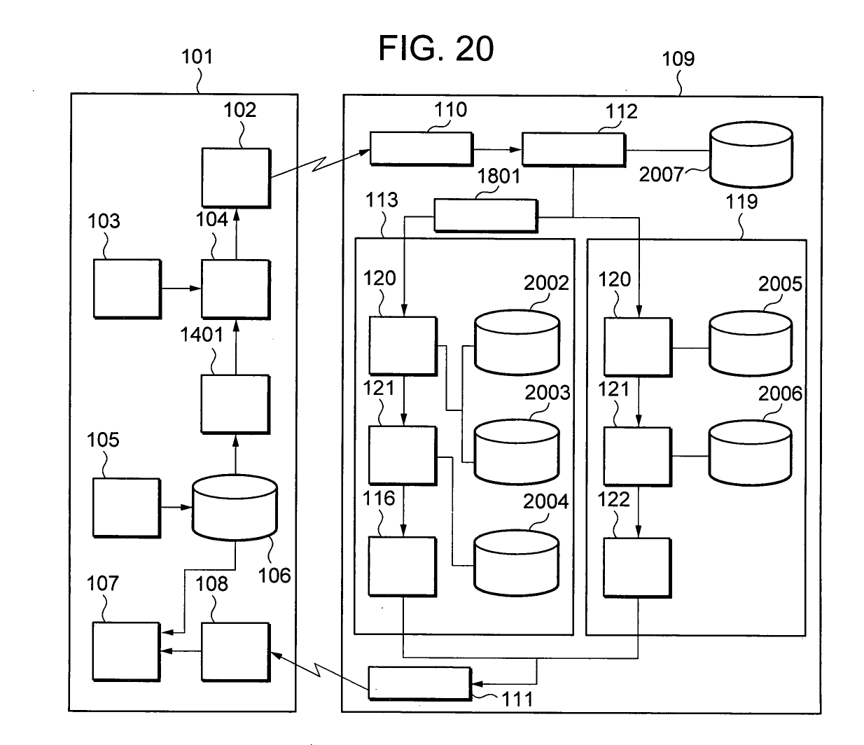

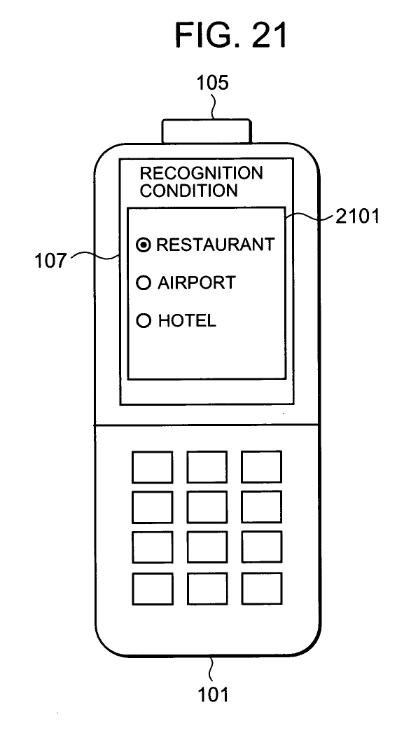

Hereinafter, Embodiment 4 of the invention will be described using FIG. 20 and FIG. 21. In each figure, reference numerals that are the same as those in figures from Embodiment 1 to 3 refer to identical items, and the explanations for the reference numerals are omitted in principle. FIG. 20 is a block diagram illustrating a mobile-terminal-type translation system according to Embodiment 4. In FIG. 20, “2001” is a GPS unit, “2002” is a special recognition dictionary, “2003” is a special language dictionary, “2004” is a first special translation dictionary, “2005” is a special reference text dictionary, “2006” is a second special translation dictionary, and “2006” is map data. FIG. 21 is an illustration illustrating an example of specifying recognition conditions, and “2101” is a selected picture.

Next, the operations will be described. A process for recognition and translation service for in-image character strings will be described first.

Here, the image photographing unit 105 photographs images including character strings and stores the photographed images into the image buffer 106 according to the same process as in Embodiment 1 through 3. Then, the image transmission control unit 1401 selects one frame of images stored in the image buffer 106. The process instructing unit 104 specifies a type and execution conditions of a process service that is executed in the server 109. Here, the recognition and translation service for in-image character strings is specified as the type of the process service.

Then, the GPS unit 2001 obtains the present position of the mobile terminal 101 by means of radio wave emitted from the satellite, using GPS function. The data sending unit 102 sends to the server 109 images specified by the image transmission control unit 1401, and information for the type of process service specified by the process instructing unit 104 and information related to the mobile terminal 101. Here, the information related to the mobile terminal 101 includes reference information (for example, model code) and the present position of the mobile terminal 101 obtained by the GPS unit 2001.

The server 109 translates character strings included in the photographed images sent from the data sending unit 102, and sends the translation result to the mobile terminal 101 as with Embodiment 1 through 3. In this case, however, the process control unit 112 refers to contents of the map data 2007 according to the present position obtained by the GPS unit 2001, and specifies the facility in which the user having the mobile terminal is. Then, dictionaries used in the in-image character string recognizing and translating unit 113 are replaced with special dictionaries related to the specified facility. Practically, the recognition dictionary 117, the language dictionary 118 and the first translation dictionary 124, which are illustrated in FIG. 1, are replaced with the special recognition dictionary 2002, the special language dictionary 2003 and the first special translation dictionary, respectively.

Here, positional information on various facilities is stored in the map data 2007, and a user can learn in which facility the user is from the present position of the mobile terminal 101 obtained by the GPS 2001. Therefore, the process control unit 112 selects a special dictionary relating to the facility. For example, when the user is in a restaurant, a special dictionary including a local dish menu often used in the restaurant, is selected. Next, the in-image character string recognizing and translating unit 113 executes the same processes as those in Embodiment 1 through 3 using each of special dictionaries 2002, 2003, and 2004. Then, the processed translation result is sent to the mobile terminal 101 and displayed on the display unit 107. The above processes are operations of the recognition and translation service for in-image character strings in Embodiment 4.

Next, operations of a text-translation service will be described.

At first, as with Embodiment 1, the user inputs keywords to translate by the key input unit 103, the process instructing unit 104 specifies a text-translation service as a type of process service processed in the server 109. The data sending unit 102 sends to the server 109 the keywords inputted through the key input unit 103, the type of process service specified by the process instructing unit 104, and information relating to the mobile terminal 101 (model code and present position obtained by the GPS unit 2001).

Hereinafter, translating process is executed as is the process with Embodiment 1, and the translation result is displayed on the display unit 107 of the mobile terminal 101. However, if the type of process service specified by the data sending unit 102 is a text-translation service, the process control unit 112 refers to contents of the map data 2007 according to the present position of the mobile terminal 101 that has been obtained by the GPS unit 2001, and specifies the facility in which the user having the mobile terminal 101 is. Then, the various dictionaries used in the text translating unit 119 are replaced with the special dictionaries related to the specified facility. Practically, the related text dictionary 123 and the second translation dictionary 125 illustrated in FIG. 1 are replaced with the special related text dictionary 2005 and the second special translation dictionary 2006 respectively. The above processes are the operations of the text-translation service in Embodiment 4.

Moreover, in the above operational explanations, though the process control unit 112 selects the type of the special dictionary according to the present position of the user obtained by the GPS unit 2001 and the map data 2007, alternatively the type of the special dictionary can be selected directly through the mobile terminal 101. For example, the process instructing unit 104 displays on the display unit 107 a selection screen 2101 that displays types of the special dictionaries such as those indicated in FIG. 21, so that the user can specify a desired type of the special dictionary among the dictionaries. Then, the process instructing unit 104 adds the information on the type of the special dictionary specified by the user to sending data and sends the data to the server 109, when the data sending unit 102 requests the server 109 to process the recognition and translation service for in-image character strings or the text-translation service. The processes described above enable the process control unit 112 to select the special dictionary specified by the user and the in-image character string recognizing and translating unit 113 or the text translating unit 119 to execute the processes.

As described above in Embodiment 4, the effect of improving in the translation performance can be obtained, because it has been enabled for the user to replace dictionaries used for character string recognizing or translating process in the server with appropriate special dictionaries, by the user specifying the dictionaries, or specifying the facility where the user is at present, according to the present position of the mobile terminal 101 obtained by the GPS unit 2001 and the map data 2007 of the server 109.

### Embodiment 5

In the recognition and translation service for in-image character strings in Embodiment 1 to 4, color images or gray-scale images photographed by the image photographing unit 105 are sent from the mobile terminal 101 to the server 109. However, it takes a time to send the color images or the gray-scale images, because data volume of these images is large. The problems are solved by creating images with reduced data volume so as to send the images to a server. Embodiment 5 aims at solving these problems.

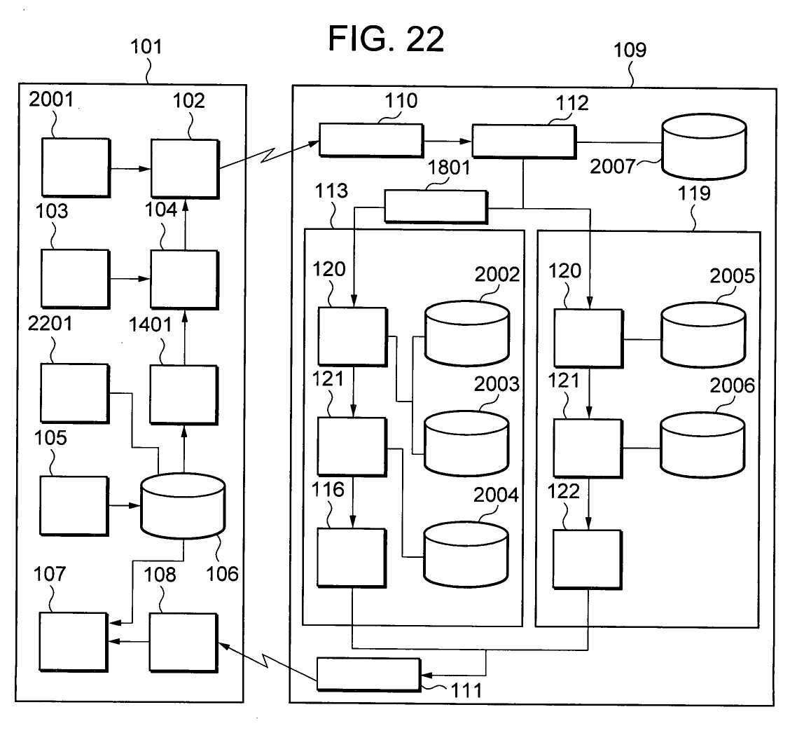

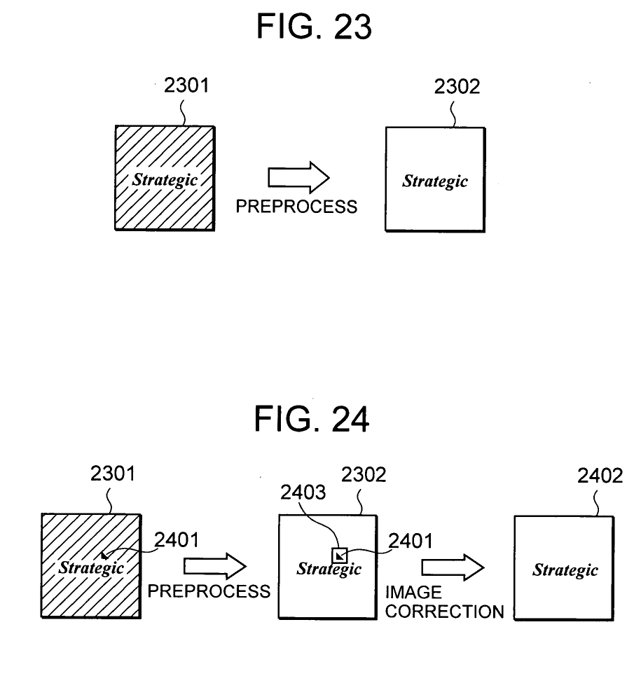

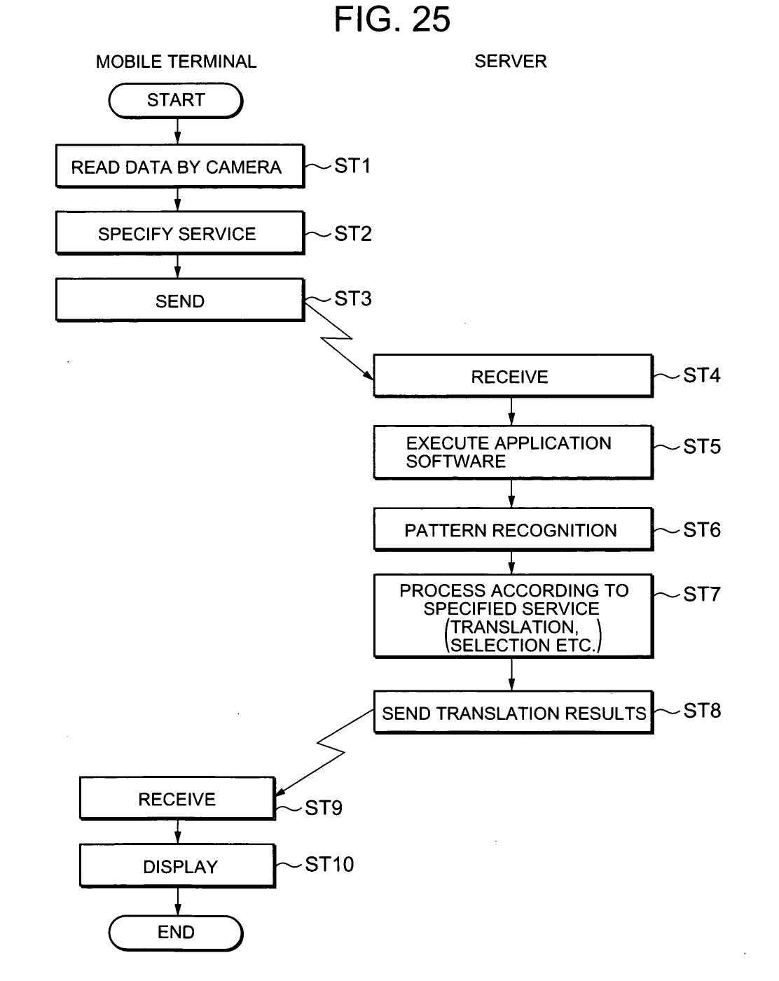

Hereinafter, Embodiment 5 of the invention will be described using from FIG. 22 to FIG. 24. In each figure, reference numerals that are the same as those in figures in Embodiment 1 to 4 refer to identical items, and the explanation for the reference numerals is omitted in principle. FIG. 22 is a block diagram illustrating a mobile-terminal-type translation system according to Embodiment 5 of the invention, and “2201” is an image preprocessing unit. FIG. 23 is an illustration illustrating an operation of the image preprocessing unit, “2301” is a photographed image, and “2302” is a preprocessed image. FIG. 24 is an illustration illustrating image correcting process in the image preprocessing unit, “2401” is a noise, “2402” is a preprocessed image in which the noise has been removed, and “2403” is a target area from which the noise is removed.

Next, the operations will be described.

At first, as with Embodiment 1 through 4, the image photographing unit 105 photographs images including character strings, and the images photographed by the image photographing unit 105 are stored into the buffer 106.

Then, the image preprocessing unit 2201 executes image-processing to the photographed images stored in the image buffer 106, and reduces data volume of the images. This image-processing is the same as the preprocessing (Step ST21 in FIG. 3) included in the procedure of the recognizing unit 114 in the server 109. For example, as illustrated in FIG. 23, monochrome preprocessed image 2302 whose character string part is black, and whose background part is white, can be obtained, when the images 2301 stored in the image buffer 106 are preprocessed. The data volume of binary-encoded images having only two colors, is less than those of color images or gray-scale images that are photographed by the image photographing unit 105. The preprocessed images whose data volume has been reduced in this way, are stored in the image buffer 106 again.

Moreover, if a noise is included in images photographed by the image photographing unit 105, the noise may sometimes remain in the preprocessed images. For example, in FIG. 24, a noise 2401 remains on the preprocessed images 2302 in black color. This kind of noise 2401 causes miss-recognition in the character recognizing process. Therefore, the image preprocessing unit 2201 has function for eliminating noise from the preprocessed images by a user. For example, the user displays the preprocessed images on the display unit 107 and visually checks the images. When the user detects a noise, a rectangular noise-removing target area 2403 that encloses the noise 2401 is specified as illustrated in FIG. 24. The area is specified by the input key unit 103. When the rectangular noise-removing area 2403 is specified, the image preprocessing unit 2201 converts black pixels to white pixels in the noise-removing area 2403, and edits the images into the noiseless preprocessed images 2402.

In the meantime, when the recognition and translation service for in-image character strings is requested from the mobile terminal 101 to the server 109, the data sending unit 102 sends the preprocessed images stored in the image buffer 106 to the server 109. Subsequent processes are the same as processes in FIG. 1 to FIG. 4. However, because the preprocessing performed in the server 109 in FIG. 1 to FIG. 4, has been performed in the mobile terminal 101, the preprocessing is skipped in the server 109 in this Embodiment 5. The server 109 receives the preprocessed images, recognizes the character strings included in the images, obtains the recognition result, and then sends the result to the mobile terminal 101. The above processes are the operations in Embodiment 5.

According to Embodiment 5 as described above, the effect of reducing the data volume, the transmission time due to color images or gray-scale images, and the processing time in the server 109, can be obtained, because the image preprocessing unit 2201 of the mobile terminal 101 executes preprocessing in the image preprocessing unit 2201, creates binary-encoded preprocessed images whose character strings and background are separated from color images or gray-scale images, sends the images to the server 109, and translates character strings included in the preprocessed images. Moreover, because noiseless preprocessed images has been made obtainable, when noise is included in the preprocessed images, the effect of eliminating causes of miss-recognition in the character recognition process in the server 109, can be obtained.

Examples in each Embodiment have been explained, which relates to configurations that have both translation process in which character strings included in images photographed by the image photographing unit are translated, and translation process in which text relating to keywords inputted through the input key unit is created and translated. These translation processes are independent each other as a system. Moreover, though the server side is configured capable of performing both processes, the mobile terminal side may be configured capable of either of the processes. In this case, however, the function of, e.g., the process instructing unit or the process control unit may be somewhat changed.

### INDUSTRIAL APPLICABLILITY

A mobile-terminal-type translating system relating to an aspect of the invention is configured as described above, and the system comprises a mobile terminal; and a server for exchanging data with the mobile terminal; the mobile terminal including an image photographing unit, an image buffer for storing images photographed by the image photographing unit, an input key unit for inputting keywords, a process instructing unit for specifying types of processing services that are requested of the server, a data sending unit for sending data to the server, wherein the data includes the images stored in the image buffer or keywords inputted through the input key unit, a specified type of processing service, and information characterizing the mobile terminal, a result receiving unit for receiving translation results translated in the server, and a display unit for displaying the received translation results; and the server including a data receiving unit for receiving the data, having been sent from the mobile terminal, an in-image character string recognizing and translating unit, for selecting a plurality of character strings with respect to a character string included in the received images, translating the plurality of selected character strings, and generating results of translating each of the character strings, a text translating unit for generating relevant text with respect to the received keywords, translating the generated relevant text, and generating a translation result, a process control unit for switching, according to the specified type of processing service, included in the received data, between processing by the in-image character string recognizing and translating unit, and processing by the text translating unit, and a result sending unit for sending, according to the characterizing information, to the mobile terminal the translation result generated by the in-image character string recognizing and translating unit or by the text translating unit; therefore an effect of realizing a system that can cope with both translations for in-image character strings and inputted text can be obtained. Moreover, because a plurality of character strings is recognized and translated in the recognizing and translating process for in-image character strings, an effect can be obtained, in which translation that has high correct translation ratio for in-image characters or an ornamental writing that are difficult to recognize, and have low resolution and poor quality can be carried out. Moreover, because keywords are inputted in text translation processes, an effect can be obtained, in which all text required to translate does not need to be inputted, and consequently troublesome work of inputting text can be eliminated.

Moreover, a mobile-terminal-type translating system relating to another aspect of the invention is configured as described above, and the system comprises a mobile terminal; and a server for exchanging data with the mobile terminal; the mobile terminal includes an image photographing unit, an image buffer for storing images photographed by the image photographing unit, a process instructing unit for instructing processing services that are requested of the server, a data sending unit for sending data to the server, wherein the data includes the images stored in the image buffer, an instruction for executing the processing service, and information characterizing the mobile terminal, a result receiving unit for receiving translation results translated in the server, and a display unit for displaying the received translation results; and the server includes a data receiving unit for receiving said data, having been sent from the mobile terminal, an in-image character string recognizing and translating unit, for selecting a plurality of character strings with respect to a character string included in the received images, translating the plurality of selected character strings, and generating results of translating each of the character strings, a process control unit for operating the recognizing and translating unit according to a processing service instruction included in the received data, and a result sending unit for sending, according to the characterizing information, to the mobile terminal the generated translation result; therefore an effect can be obtained, in which translation that has high correct translation ratio even for in-image characters or ornamental writings that are difficult to recognize, and have low resolution and poor quality can be carried out.

Moreover, a mobile-terminal-type translating system relating to another aspect of the invention is configured as described above, and the system comprises a mobile terminal; and a server for exchanging data with the mobile terminal; the mobile terminal includes an input key unit for inputting keywords, a process instructing unit for instructing processing services that are requested of the server, a data sending unit for sending data to the server, wherein the data includes keywords inputted through the input key unit, an instruction for executing the processing service, and information characterizing the mobile terminal, a result receiving unit for receiving translation results translated in the server, and a display unit for displaying the received translation results; and the server including a data receiving unit for receiving the data, having been sent from the mobile terminal, a text translating unit for generating relevant text with respect to the keywords included in the received data, translating the generated relevant text, and generating the translation result, a process control unit for operating the text translating unit according to a processing service instruction, included in the received data, and a result sending unit for sending, according to the characterizing information, to the mobile terminal the generated translation result; therefore, because keywords are inputted in text translation processes, an effect can be obtained, in which all text required to translate does not need to be inputted, and consequently troublesome work of inputting text can be eliminated.

Moreover, a mobile-terminal-type translating system relating to another aspect of the invention is configured as described above, and the in-image character-string recognizing and translating unit of the server comprises an in-image character-string recognizing unit for recognizing under plural differing conditions a character string in an image, to generate a plurality of character-string recognition results; and an in-image character-string translating unit for generating a plurality of translation results in which each of the generated plurality of character-string recognition results is translated; therefore an effect can be obtained, in which translation that has high correct translation ratio for in-image characters or an ornamental writing that are difficult to recognize, and have low resolution and poor quality can be carried out.

Moreover, a mobile-terminal-type translating system relating to another aspect of the invention is configured as described above, and the in-image character-string recognizing and translating unit of the server comprises an in-image character-string recognizing unit for recognizing under plural differing conditions a character string in an image, to generate a plurality of character-string recognition results, and for generating similar character strings, by using a language dictionary, whose spellings are similar to those of the plurality of character-string recognition results; and an in-image character-string translating unit for generating a plurality of translation results by translating both the generated character-string recognition results and the similar character strings; therefore an effect can be obtained, in which translation that has high correct translation ratio for in-image characters or ornamental writings that are difficult to recognize, and have low resolution and poor quality can be carried out.

Moreover, a mobile-terminal-type translating system relating to another aspect of the invention is configured as described above, and the text translating unit of the server comprises a relevant text generating unit for generating a plurality of text items closely relating to the received keywords by referring to a relevant text dictionary according to the received keywords; and a relevant text translating unit for translating the plurality of generated text items to generate translation results; therefore, because keywords are inputted in text translation processes, an effect can be obtained, in which not only all text required to translate does not need to be inputted, and consequently troublesome work of inputting text can be eliminated, but also translation that has high correct translation ratio can be carried out.

Moreover, a mobile-terminal-type translating system relating to another aspect of the invention is configured as described above, and the mobile terminal comprises a sending-image control unit for sequentially selecting each of images that have been sequentially photographed by the image photographing unit at constant time intervals and stored in the image buffer, and for outputting the images to the data sending unit; the server sequentially generates each of results of translating character strings included in each of the received images and sends the results to the mobile terminal; and the display unit of the mobile terminal displays each translation result each time a translation result is received; therefore an effect can be obtained, in which a user needs not to repeat works of moving the camera view along the character strings required to translate and to press the shutter, resulting in reducing troublesome work and in obtaining a translation result in semi-real time.

Moreover, a mobile-terminal-type translating system relating to another aspect of the invention is configured as described above, and, with respect to images sequentially read from the image buffer, the transmission control unit of the mobile terminal compares the difference between a newly photographed image and the immediately preceding photographed image, and if the difference is less than a threshold value, selects the newly photographed image and outputs the image to the data sending unit; therefore translation results of only images including character strings from a plurality of images, which a user requests to translate, can be obtained; and consequently, an effect can be obtained, in which a data sending amount and a server processing amount can be reduced.

Moreover, a mobile-terminal-type translating system relating to another aspect of the invention is configured as described above, and the server comprises an image integrating unit for combining a plurality of sequentially received images to generate one composite image frame, and the in-image character-string recognizing and translating unit generates translation results with respect to character strings included in the generated composite images; therefore an effect of translating contents of long character strings or text, all of which do not appear in a camera view, can be obtained.

Moreover, a mobile-terminal-type translating system relating to another aspect of the invention is configured as described above, and the mobile terminal comprises a GPS unit for obtaining information on the present position of the mobile terminal and adds the positional information to data to be sent to the server; the server includes map data that includes information on the position of different facilities; and the process control unit of the server identifies the facility where the mobile terminal user is at present, by referring to the map data based on the received present positional information, and replaces various dictionaries used in the server with specialized dictionaries with respect to the identified facility; therefore an effect of improving in the translation performance can be obtained by a user unintentionally changing dictionaries to most appropriate ones.

Moreover, a mobile-terminal-type translating system relating to another aspect of the invention is configured as described above, and the process instructing unit of the mobile terminal is configured such that specialized dictionary categories can be designated by a user, and information on a designated specialized dictionary category is added to data to be sent to the server; and the process control unit of the server replaces various dictionaries used in the server with specialized dictionaries according to a received specialized dictionary category; therefore the system can cope with translations in accordance with user's requests; and consequently an effect of improving in the translation performance can be obtained.

Moreover, a mobile-terminal-type translating system relating to another aspect of the invention is configured as described above, and the mobile terminal comprises an image preprocessing unit for generating binary encoded preprocessed images so as to separate character strings and backgrounds from color images or gray-scale images, and storing the images into the image buffer, wherein the mobile terminal sends the preprocessed images to the server, and obtains a translation result; therefore an effect can be obtained, in which not only the data volume and the transmission time due to color images or gray-scale images, but also the processing time in the server are reduced.

Moreover, a mobile-terminal-type translating system relating to another aspect of the invention is configured as described above, and the mobile terminal is configured such that, when noise is included in the preprocessed images, the terminal can designate through key input a noise-removal target area surrounding the noise; and the image preprocessing unit edits the preprocessed images by converting black pixels in the noise-removal target area into white pixels; therefore an effect of eliminating causes of miss-recognition in the character recognition process on the server side can be obtained.

Moreover, a mobile-terminal-type translating system relating to another aspect of the invention is configured as described above, and the mobile terminal for exchanging data with a server that carries out translation processes comprises: an image photographing unit; an image buffer for storing images photographed by the image photographing unit; an input key unit for inputting keywords; a process instructing unit for specifying types of processing services that are requested of the server; a data sending unit for sending data to the server, wherein the data includes the images stored in the image buffer or inputted keywords, a specified type of processing service, and information characterizing the mobile terminal; a result receiving unit for receiving character strings recognized, and translation results translated, in the server; and a display unit for displaying the received translation results; therefore an effect of realizing a mobile terminal, which can cope with both services of translating in-image character strings on the server side and translating inputted text, can be obtained.

Moreover, a mobile-terminal-type translating system relating to another aspect of the invention is configured as described above, and the mobile terminal for exchanging data with a server that carries out translation processes comprises: an image photographing unit; an image buffer for storing images photographed by the image photographing unit; a process instructing unit for instructing processing services that are requested of the server; a data sending unit for sending data to the server, wherein the data includes the images stored in the image buffer, the instruction for executing the processing services, and information characterizing the mobile terminal; a result receiving unit for receiving character strings recognized, and translation results translated, in the server; and a display unit for displaying the received translation results; therefore an effect of realizing a mobile terminal can be obtained, in which a user can request to translate in image character-strings on the server side and the translation result can be received and displayed.

Moreover, a mobile-terminal-type translating system relating to another aspect of the invention is configured as described above, and the mobile terminal for exchanging data with the server for translating comprises: an input key unit for inputting keywords; a process instructing unit for instructing processing services that are requested of the server; a data sending unit for sending data to the server, wherein the data includes the inputted keywords, instructions for executing the processing services, and information characterizing the mobile terminal; a result receiving unit for receiving translation results translated in the server; and a display unit for displaying the received translation results; therefore an effect of realizing a mobile terminal, which can cope with translation service related to inputted keywords in which all text required to translate does not need to be inputted, can be obtained.

Moreover, a mobile-terminal-type translating system relating to another aspect of the invention is configured as described above, and the system comprises a sending-image control unit for sequentially selecting each of images that have been sequentially photographed by the image photographing unit at constant time intervals and stored in the image buffer, and for outputting the images to the data sending unit, in which the displaying unit sequentially displays each result of translating character strings included in each image sequentially received from the server; therefore an effect of realizing a mobile terminal can be obtained, in which a user needs not to repeat works of moving the camera view along the character strings required to translate and to press the shutter, resulting in reducing troublesome work and in obtaining a translation result in semi-real time.

Moreover, a mobile-terminal-type translating system relating to another aspect of the invention is configured as described above, and, with respect to images sequentially read from the image buffer, the transmission control unit compares the difference between a newly photographed image and the immediately preceding photographed image, and if the difference is less than a threshold value, selects the newly photographed image and outputs the image to the data sending unit; therefore translation results of only images including character strings from a plurality of images, which a user requests to translate, can be obtained, and an effect of realizing a mobile terminal can be obtained, in which a data sending amount and a server processing amount can be reduced.

Moreover, a mobile-terminal-type translating system relating to another aspect of the invention is configured as described above, and the system comprises a GPS unit for using GPS functions to obtain information on the present position of the mobile terminal, and for adding the information to data to be sent to the server; therefore an effect of realizing a mobile terminal can be obtained, which is suited to the case where translation is carried out on the server side using appropriate dictionaries without user's intention.

Moreover, a mobile-terminal-type translating system relating to another aspect of the invention is configured as described above, and the process instructing unit is configured such that specialized dictionary categories can be designated by a user, and information on a designated special dictionary category is added to data to be sent to the server; therefore an effect for realizing a mobile terminal can be obtained, which is suited to the case where translation is carried out on the server side using appropriate dictionaries in accordance with user's requests.

Moreover, a mobile-terminal-type translating system relating to another aspect of the invention is configured as described above, and the system comprises an image preprocessing unit for generating binary encoded preprocessed images so as to separate character strings and backgrounds from color images or gray-scale images stored in the image buffer, and storing the images into the image buffer, wherein the preprocessed images are read from the image buffer and sent to the server enabling to obtain a translation result; therefore an effect of realizing a mobile terminal can be obtained, in which not only the data volume and the transmission time due to color images or gray-scale images, but also the processing time in the server can be reduced.

Moreover, a mobile-terminal-type translating system relating to another aspect of the invention is configured as described above, and the mobile terminal is configured such that, when noise is included in the preprocessed images, the terminal can designate through key input a noise-removal target area surrounding the noise, and the image preprocessing unit edits the preprocessed images by converting black pixels in the noise-removing area into white pixels; therefore an effect of realizing a mobile terminal that eliminates causes of miss-recognition in the character recognition process in the server, can be obtained.

Moreover, a mobile-terminal-type translating system relating to another aspect of the invention is configured as described above, and the system comprises: a server for exchanging data with a mobile terminal including a data receiving unit for receiving data that includes images, having been sent from the mobile terminal or key-inputted keywords, a specified type of processing service, and information characterizing the mobile terminal; an in-image character string recognizing and translating unit, for selecting a plurality of character strings with respect to a character string included in the received images, translating the plurality of selected character strings, and generating respective results of translating the character strings; a text translating unit for generating relevant text with respect to the keywords, and translating the relevant text so as to generate a translation result; a process control unit for switching, according to the specified type of processing service, between processing by the in-image character-string recognizing and translating unit, and processing by the text translating unit; and a result sending unit for according to the correlating information sending to the mobile terminal the translation result generated in the in-image character-string recognizing and translating unit or in the text translating unit; therefore an effect of realizing a server that can cope with both translations for in-image character strings and inputted text can be obtained. Moreover, because relevant text is generated from inputted keywords, an effect can be obtained, in which not only all text required to translate does not need to be inputted and translation result requested from a user is obtained, but also burdens on a user, when inputting on the server side, can be reduced.

Moreover, a mobile-terminal-type translating system relating to another aspect of the invention is configured as described above, and the system comprises: a server for exchanging data with a mobile terminal including a data receiving unit for receiving data that includes images, having been sent from the mobile terminal, an instruction for executing the processing service, and information characterizing the mobile terminal; an in-image character string recognizing and translating unit, for selecting a plurality of character strings with respect to a character string included in the received images, translating the plurality of selected character strings, and generating respective results of translating the character strings; a process control unit for operating the recognizing and translating unit according to a processing service instruction included in the received data; a result sending unit for sending, according to the characterizing information, to the mobile terminal the translation result generated in the in-image character-string recognizing and translating unit or in the text translating unit; therefore an effect of realizing the server can be obtained, in which a translation result that has high correct translation ratio even for in-image characters or an ornamental writing that are difficult to recognize, and have low resolution and poor quality can be obtained.

Moreover, a mobile-terminal-type translating system relating to another aspect of the invention is configured as described above, and the system comprises: a server for exchanging data with a mobile terminal including a data receiving unit for receiving data that includes inputted keywords, an instruction for executing the processing service, and information characterizing the mobile terminal; a text translating unit for generating relevant text with respect to the keywords, translating the generated relevant text, and generating a translation result; a process control unit for operating the text translating unit according to the processing service instruction included in the received data; and a result sending unit for sending, according to the characterizing information, to the mobile terminal the translation result generated in the text translating unit; therefore, because relevant text is generated from inputted keywords, a server can be realized, in which a translation result requested from a user can be obtained; and consequently an effect can be obtained, in which burdens on a user, when inputting on the server side, can be reduced.

Moreover, a mobile-terminal-type translating system relating to another aspect of the invention is configured as described above, and the in-image character string recognizing and translating unit comprises an in-image character-string recognizing unit for recognizing under plural differing conditions a character string in an image, to generate a plurality of character-string recognition results, and an in-image character-string translating unit for generating a plurality of translation results in which each of the generated plurality of character-string recognition results is translated; therefore an effect of realizing a server can be obtained, in which translation that has high correct translation ratio for in-image characters or an ornamental writing that are difficult to recognize, and have low resolution and poor quality can be carried out.

Moreover, a mobile-terminal-type translating system relating to another aspect of the invention is configured as described above, and the in-image character-string recognizing and translating unit of the server comprises: an in-image character-string recognizing unit for recognizing under plural differing conditions a character string in an image, to generate a plurality of character-string recognition results, and for generating similar character strings, by using a language dictionary, whose spellings are similar to those of the plurality of character-string recognition results; and an in-image character-string translating unit for generating a plurality of translation results by translating both the generated character-string recognition results and the similar character strings; therefore an effect of realizing the server can be obtained, in which translation that has high correct translation ratio for in-image characters or an ornamental writing that are difficult to recognize, and have low resolution and poor quality can be carried out.

Moreover, a mobile-terminal-type translating system relating to another aspect of the invention is configured as described above, and the text translating unit comprises a relevant text generating unit for referring to a relevant text dictionary according to keywords inputted through an input key unit and generating a plurality of text items closely relating to the keywords, and a relevant text translating unit for translating the plurality of generated text items to generate translation results; therefore, because relevant text is generated from inputted keywords, an effect of realizing the server can be obtained, in which, coping with user's request, translation results that have high correct translation ratio is obtained even if all text requested to translate is not received, and burdens on a user can be reduced when inputting on the server side.

Moreover, a mobile-terminal-type translating system relating to another aspect of the invention is configured as described above, and the system comprises an image integrating unit for combining a plurality of sequentially received images to generate one frame of composite images; in which the in-image character-string recognizing and translating unit generates translation results relating to character strings included in the generated composite images; therefore an effect of realizing a server for translating contents of long character strings or text, all of which do not appear in a camera view, can be obtained.

Moreover, a mobile-terminal-type translating system relating to another aspect of the invention is configured as described above, and the system comprises map data that stores information on the position of different facilities, in which the process control unit of the server identifies the facility where the mobile terminal user is at present, by referring to the map data based on the received present positional information, and replaces various dictionaries used in the server with specialized dictionaries with respect to the identified facility; therefore an effect of realizing a server for improving in the translation performance can be obtained by changing dictionaries to appropriate ones without user's intention.

Moreover, a mobile-terminal-type translating system relating to another aspect of the invention is configured as described above, and the process control unit replaces various dictionaries used in the server with specialized dictionaries according to a received specialized dictionary category; therefore an effect of realizing a server capable of coping with translations according to user's requests and improving in the translation performance, can be obtained.

1. A mobile-terminal-type image processing system comprising:
a mobile terminal; and
a server for exchanging data with the mobile terminal;
the mobile terminal including
an image photographing unit,
an image buffer for storing images photographed by the image photographing unit,
an input key unit for inputting keywords,
a process instructing unit for specifying types of processing services that are requested of the server,
a data sending unit for sending data to the server, wherein the data includes the images stored in the image buffer or keywords inputted through the input key unit, a specified type of processing service, and information characterizing the mobile terminal,
a result receiving unit for receiving translation results translated in the server, and
a display unit for displaying the received translation results; and
the server including
a data receiving unit for receiving said data, having been sent from the mobile terminal,
an in-image character string recognizing and translating unit, for selecting a plurality of character strings with respect to a character string included in the received images, translating the plurality of selected character strings, and generating results of translating each of the character strings,
a text translating unit for generating relevant text with respect to the received keywords, translating the generated relevant text, and generating translation results,
a process control unit for switching, according to the specified type of processing service, included in the received data, between processing by the in-image character string recognizing and translating unit, and processing by the text translating unit, and
a result sending unit for sending, according to the characterizing information, to the mobile terminal the translation results generated by the in-image character string recognizing and translating unit or by the text translating unit.

2. A mobile-terminal-type image processing system comprising:
a mobile terminal; and
a server for exchanging data with the mobile terminal;
the mobile terminal including
an image photographing unit,
an image buffer for storing images photographed by the image photographing unit,
a process instructing unit for instructing processing services that are requested of the server,
a data sending unit for sending data to the server, wherein the data includes the images stored in the image buffer, an instruction for executing the processing service, and information characterizing the mobile terminal,
a result receiving unit for receiving translation results translated in the server, and
a display unit for displaying the received translation results; and
the server including
a data receiving unit for receiving said data, having been sent from the mobile terminal,
an in-image character string recognizing and translating unit, for selecting a plurality of character strings with respect to a character string included in the received images, translating the plurality of selected character strings, and generating results of translating each of the character strings,
a process control unit for operating the recognizing and translating unit according to the processing service instruction included in the received data, and
a result sending unit for sending, according to the characterizing information, to the mobile terminal the generated translation results.

3. A mobile-terminal-type image processing system comprising:
a mobile terminal; and
a server for exchanging data with the mobile terminal;
the mobile terminal including
an input key unit for inputting keywords,
a process instructing unit for instructing processing services that are requested of the server,
a data sending unit for sending data to the server, wherein the data includes keywords inputted through the input key unit, an instruction for executing the processing service, and information characterizing the mobile terminal,
a result receiving unit for receiving translation results translated in the server, and
a display unit for displaying the received translation result; and
the server including
a data receiving unit for receiving said data, having been sent from the mobile terminal,
a text translating unit for generating relevant text with respect to the keywords included in the received data, translating the generated relevant text, and generating the translation result,
a process control unit for operating the text translating unit according to the processing service instruction, included in the received data, and
a result sending unit for sending, according to the characterizing information, to the mobile terminal the generated translation results.

4. A mobile-terminal-type image processing system as recited in claim 1 or claim 2, wherein the in-image character-string recognizing and translating unit of the server further comprises:
an in-image character-string recognizing unit for recognizing under plural differing conditions a character string in an image, to generate a plurality of character-string recognition results; and
an in-image character-string translating unit for generating a plurality of translation results in which each of the generated plurality of character-string recognition results is translated.

5. A mobile-terminal-type image processing system as recited in claim 1 or claim 2, wherein the in-image character-string recognizing and translating unit of the server further comprises:
an in-image character-string recognizing unit for recognizing under plural differing conditions a character string in an image, to generate a plurality of character-string recognition results, and for generating similar character strings, by using a language dictionary, whose spellings are similar to those of the plurality of character-string recognition results; and
an in-image character-string translating unit for generating a plurality of translation results by translating both the generated character-string recognition results and the similar character strings.

6. A mobile-terminal-type image processing system as recited in claim 1 or claim 3, wherein the text translating unit of the server further comprises:
a relevant text generating unit for generating a plurality of text items closely relating to the received keywords by referring to a relevant text dictionary according to the received keywords; and
a relevant text translating unit for translating the plurality of generated text items to generate translation results.

7. A mobile-terminal-type image processing system as recited in claim 1 or claim 2, wherein:
the mobile terminal further comprises a sending-image control unit for sequentially selecting each of images that have been sequentially photographed by the image photographing unit at constant time intervals and stored in the image buffer, and for outputting the images to the data sending unit;
the server sequentially generates each of results of translating character strings included in each of the received images and sends the results to the mobile terminal; and
the display unit of the mobile terminal displays each translation result each time a translation result is received.

8. A mobile-terminal-type image processing system as recited in claim 7, wherein, with respect to images sequentially read from the image buffer, a transmission control unit of the mobile terminal compares the difference between a newly photographed image and the immediately preceding photographed image, and if the difference is less than a threshold value, selects the newly photographed image and outputs the image to the data sending unit.

9. A mobile-terminal-type image processing system as recited in claim 7 or claim 8, wherein:
the server further comprises an image integrating unit for combining a plurality of sequentially received images to generate one composite image frame, and
the in-image character-string recognizing and translating unit generates translation results with respect to character strings included in the generated composite images.

10. A mobile-terminal-type image processing system as recited in any of claim 1 through claim 9, wherein:
the mobile terminal comprises a GPS unit for obtaining information on the present position of the mobile terminal and adds the positional information to data to be sent to the server;
the server includes map data that includes information on the position of different facilities; and
the process control unit of the server identifies the facility where the mobile terminal user is at present, by referring to the map data based on the received present positional information, and replaces various dictionaries used in the server with specialized dictionaries with respect to the identified facility.

11. A mobile-terminal-type image processing system as recited in any of claim 1 through claim 9, wherein
the process instructing unit of the mobile terminal is configured such that specialized dictionary categories can be designated by a user, and information on a designated specialized dictionary category is added to data to be sent to the server; and
the process control unit of the server replaces various dictionaries used in the server with specialized dictionaries according to a received specialized dictionary category.

12. A mobile-terminal-type image processing system as recited in any of claim 1, claim 3 through claim 5, or claim 7 through claim 11, the mobile terminal further comprising an image preprocessing unit for generating binary encoded preprocessed images so as to separate character strings and backgrounds from color images or gray-scale images, and storing the images into the image buffer; wherein the mobile terminal sends the preprocessed images to the server, and obtains a translation result.

13. A mobile-terminal-type image processing system as recited in claim 12, wherein
the mobile terminal is configured such that, when noise is included in the preprocessed images, the terminal can designate through key input a noise-removal target area surrounding the noise; and
the image preprocessing unit edits the preprocessed images by converting black pixels in the noise-removal target area into white pixels.

14. A mobile terminal for exchanging data with a server that carries out translation processes, comprising:
an image photographing unit;
an image buffer for storing images photographed by the image photographing unit;
an input key unit for inputting keywords;
a process instructing unit for specifying types of processing services that are requested of the server,
a data sending unit for sending data to the server, wherein the data includes the images stored in the image buffer or inputted keywords, a specified type of processing service, and information characterizing the mobile terminal;
a result receiving unit for receiving character strings recognized, and translation results translated, in the server; and
a display unit for displaying the received translation results.

15. A mobile terminal for exchanging data with a server that carries out translation processes, comprising:
an image photographing unit;
an image buffer for storing images photographed by the image photographing unit;
a process instructing unit for instructing processing services that are requested of the server;
a data sending unit for sending data to the server, wherein the data includes the images stored in the image buffer, the instruction for executing the processing services, and information characterizing the mobile terminal;
a result receiving unit for receiving character strings recognized, and translation results translated, in the server; and
a display unit for displaying the received translation results.

16. A mobile terminal for exchanging data with a server that carries out translation processes, comprising:
an input key unit for inputting keywords;
a process instructing unit for instructing processing services that are requested of the server;
a data sending unit for sending data to the server, wherein the data includes the inputted keywords, instruction for executing the processing services, and information characterizing the mobile terminal;
a result receiving unit for receiving translation results translated in the server; and
a display unit for displaying the received translation results.

17. A mobile terminal as recited in claim 14 or claim 15, further comprising
a sending-image control unit for sequentially selecting each of images that have been sequentially photographed by the image photographing unit at constant time intervals and stored in the image buffer, and for outputting the images to the data sending unit; wherein
the displaying unit sequentially displays each result of translating character strings included in each image sequentially received from the server.

18. A mobile terminal as recited in claim 17, wherein, with respect to images sequentially read from the image buffer, a transmission control unit compares the difference between a newly photographed image and the immediately preceding photographed image, and if the difference is less than a threshold value, selects the newly photographed image and outputs the image to the data sending unit.

19. A mobile terminal as recited in any of claim 14 through claim 18, further comprising a GPS unit for using GPS functions to obtain information on the present position of the mobile terminal, and for adding the information to data to be sent to the server.

20. A mobile terminal as recited in any of claim 14 through claim 18, wherein the process instructing unit is configured such that specialized dictionary categories can be designated by a user, and information on a designated special dictionary category is added to data to be sent to the server.

21. A mobile terminal as recited in any of claim 14, claim 15, and claim 17 through claim 20, further comprising an image preprocessing unit for generating binary encoded preprocessed images so as to separate character strings and backgrounds from color images or gray-scale images stored in the image buffer, and storing the images into the image buffer, wherein the preprocessed images are read from the image buffer and sent to the server enabling to obtain a translation result.

22. A mobile terminal as recited in claim 21, wherein
the mobile terminal is configured such that, when noise is included in the preprocessed images, the terminal can designate through key input a noise-removal target area surrounding the noise; and
the image preprocessing unit edits the preprocessed images by converting black pixels in the noise-removing area into white pixels.

23. A server for exchanging data with a mobile terminal comprising:
a data receiving unit for receiving data that includes images, having been sent from the mobile terminal or key-inputted keywords, a specified type of processing service, and information characterizing the mobile terminal;
an in-image character string recognizing and translating unit, for selecting a plurality of character strings with respect to a character string included in the received images, translating the plurality of selected character strings, and generating respective results of translating the character strings;
a text translating unit for generating relevant text with respect to the keywords, and translating the relevant text so as to generate a translation result;
a process control unit for switching, according to the specified type of processing service, between processing by the in-image character-string recognizing and translating unit, and processing by the text translating unit; and
a result sending unit for according to the correlating information sending to the mobile terminal the translation results generated in the in-image character-string recognizing and translating unit or in the text translating unit.

24. A server for exchanging data with a mobile terminal comprising:
a data receiving unit for receiving data that includes images, having been sent from the mobile terminal, an instruction for executing a processing service, and information characterizing the mobile terminal;
an in-image character string recognizing and translating unit, for selecting a plurality of character strings with respect to a character string included in the received images, translating the plurality of selected character strings, and generating respective results of translating the character strings;
a process control unit for operating the recognizing and translating unit according to a processing service instruction included in the received data;
a result sending unit for sending, according to the characterizing information, to the mobile terminal the translation results generated in the in-image character-string recognizing and translating unit or in the text translating unit.

25. A server for exchanging data with a mobile terminal comprising:
a data receiving unit for receiving data that includes inputted keywords, an instruction for executing a processing service, and information characterizing the mobile terminal;
a text translating unit for generating relevant text with respect to the keywords, translating the generated relevant text, and generating a translation result;
a process control unit for operating the text translating unit according to the processing service instruction included in the received data; and
a result sending unit for sending, according to the characterizing information, to the mobile terminal the translation result generated in the text translating unit.

26. A server as recited in claim 23 or claim 24, wherein the in-image character string recognizing and translating unit further comprises:
an in-image character-string recognizing unit for recognizing under plural differing conditions a character string in an image, to generate a plurality of character-string recognition results; and
an in-image character-string translating unit for generating a plurality of translation results in which each of the generated plurality of character-string recognition results is translated.

27. A server as recited in claim 23 or claim 24, wherein the in-image character-string recognizing and translating unit of the server further comprises:
an in-image character-string recognizing unit for recognizing under plural differing conditions a character string in an image, to generate a plurality of character-string recognition results, and for generating similar character strings, by using a language dictionary, whose spellings are similar to those of the plurality of character-string recognition results; and
an in-image character-string translating unit for generating a plurality of translation results by translating both the generated character-string recognition results and the similar character strings.

28. A server as recited in claim 25, wherein the text translating unit further comprises;
a relevant text generating unit for referring to a relevant text dictionary according to keywords inputted through an input key unit and generating a plurality of text items closely relating to the keywords, and
a relevant text translating unit for translating the plurality of generated text items to generate translation results.

29. A server as recited in any of claim 23, claim 24, claim 26, or claim 27 further comprising an image integrating unit for combining a plurality of sequentially received images to generate one frame of composite images, wherein
the in-image character-string recognizing and translating unit generates translation results relating to character strings included in the generated composite images.

30. A server as recited in any of claim 23 through claim 29 further comprising map data that stores information on the position of different facilities; wherein the process control unit of the server identifies the facility where the mobile terminal user is at present, by referring to the map data based on the received present positional information, and replaces various dictionaries used in the server with specialized dictionaries with respect to the identified facility.

31. A server as recited in any of claim 23 through claim 29; wherein the process control unit replaces various dictionaries used in the server with specialized dictionaries according to a received specialized dictionary category.
